(19) United States
(12) Patent Application Publication
(10) Pub. No.: US 2026/0262145 A1
(43) Pub. Date: Sep. 3, 2026

(54) DOOR LOCKING MECHANISM AND HOUSING ASSEMBLY FOR AIR FRY MICROWAVE

(71) Applicant: SharkNinja Operating LLC, Needham, MA (US)

(72) Inventors: Sean Dorsey, Westborough, MA (US); Edward Brown, London (GB); Ethan Brown, Wayland, MA (US); Gianluca Sergio Mazzi, Allston, MA (US); Amanda Ng, Jamaica Plain, MA (US); Kevin O'Malley, London (GB)

(21) Appl. No.: 19/067,375

(22) Filed: Feb. 28, 2025

(51) Int. Cl. H05B 6/64; A47J 37/06

(52) U.S. Cl. CPC H05B 6/6494; A47J 37/0641; A47J 37/0664

(57) ABSTRACT

A device may include a housing including a first aperture and a second aperture spaced from the first aperture, a button positioned on the housing and configured to more relative to the housing from a first position to a second position, a first rod extending from the button and configured to pass through the first aperture when the button is in the second position, a second rod extending from the button and configured to pass through the second aperture when the button is in the second position, and a blocking member positioned between the button and the housing, the blocking member including a surface configured to selectively cover the second aperture, thereby preventing the second rod from passing through the second aperture.

### FIELD

A countertop cooking system including one or more convection and radiant heating elements in combination with a microwave heating element, and methods for using the same, are provided.

### BACKGROUND

Traditional microwave cooking systems typically include a microwave source (i.e., a magnetron) that directs microwave energy at food disposed in a cooking compartment therein. The microwave energy heats water molecules in the food, turning the water molecules into steam. Since a traditional microwave only includes a microwave source, the air in the microwave is relatively cool, which allows the steam to condense once microwaves are no longer absorbed by the food. This rapid condensing of steam means that moisture is left on the surface of the food, which leads to an undesirable reheating or cooking result, since there is no means of evaporation to remove the moisture created during the microwaving process.

### SUMMARY

In some aspects, the techniques described herein relate to a device, including: a housing including a first aperture and a second aperture spaced from the first aperture; a button positioned on the housing and configured to more relative to the housing from a first position to a second position; a first rod extending from the button and configured to pass through the first aperture when the button is in the second position; a second rod extending from the button and configured to pass through the second aperture when the button is in the second position; and a blocking member positioned between the button and the housing, the blocking member including a surface configured to selectively cover the second aperture, thereby preventing the second rod from passing through the second aperture.

In some aspects, the techniques described herein relate to a device, wherein the first rod is shorter than the second rod.

In some aspects, the techniques described herein relate to a device, wherein the blocking member is selectively moved from a first position where the blocking member is misaligned with the first aperture to a second positioned where the blocking member is aligned with the first aperture.

In some aspects, the techniques described herein relate to a device, wherein the blocking member is moved from the first position to the second position via an electric motor.

In some aspects, the techniques described herein relate to a device, wherein the blocking member is moved from the first position to the second position via a button extending outward from the housing that abuts the blocking member.

In some aspects, the techniques described herein relate to a device, wherein the blocking member moves from the first position to the second position along a linear path.

In some aspects, the techniques described herein relate to a device, wherein the blocking member pivots about an axis from the first position to the second position.

In some aspects, the techniques described herein relate to a device, including: a base plate including at least one sidewall extending upward from the base plate; a corner portion formed from the sidewall and the base plate including a curved outer surface configured to prevent arc discharge on the sidewall or base plate; and a plurality of oblong-shaped apertures positioned within the base plate, wherein the oblong apertures are configured to prevent arc discharge from occurring on the base plate.

In some aspects, the techniques described herein relate to a device, wherein the device is configured to receive electromagnetic waves and prevent arc discharge from occurring on the device.

In some aspects, the techniques described herein relate to a device, wherein the base plate includes a handle positioned on the base plate.

In some aspects, the techniques described herein relate to a device, wherein the corner portion extends vertically upward from the sidewall.

In some aspects, the techniques described herein relate to a device, wherein a non-conductive member is positioned on the curved outer surface of the corner portion.

In some aspects, the techniques described herein relate to a device, including: a housing including an internal volume configured to receive a food product and an opening to allow fluid access to the internal volume; an air movement device positioned within the internal volume and configured to generate an airflow; a baffle having a first end and a second end extending partially along the opening and positioned inward from the opening towards the internal volume; a channel extending outward from the opening; a wall positioned within the channel to separate the channel into an inlet portion and an outlet portion, wherein the wall connects to the second end of the baffle; wherein, a low pressure zone is formed at the first end of the baffle as the airflow is generated within the internal volume, drawing in fluid from outside of the housing into the internal volume.

In some aspects, the techniques described herein relate to a device, wherein the outlet portion of the channel is smaller than the inlet portion of the channel.

In some aspects, the techniques described herein relate to a device, wherein fluid from within the internal volume is exhausted through the outlet portion of the channel when the airflow is generated.

In some aspects, the techniques described herein relate to a device, wherein the baffle and wall create a venturi effect at the first end of the baffle.

In some aspects, the techniques described herein relate to a device, wherein the first end of the baffle is open, and the second end of the baffle is closed, and mates with the wall within the channel to fluidly seal the inlet portion from the outlet portion along the channel.

In some aspects, the techniques described herein relate to a device, including: a housing forming a cooking chamber therein, the cooking chamber including an inner wall having a rail thereon, wherein a first indent is positioned on the rail at a first position along an insertion axis, and a second indent is positioned on the rail at a second position along the insertion axis; a microwave source positioned outside of the cooking chamber, and configured to emit microwaves; an air movement configured to generate an airflow; a heating element configured to heat the airflow to create a heated airflow within the cooking chamber; and a container selectively removable from the cooking chamber along the insertion axis, the container including a top opening and a projection extending outward from the top opening, wherein a dedent is positioned on the projection, wherein the first indent and the second indent correspond to the dedent such that the dedent is partially received by the first indent when the container is fully positioned within the cooking chamber, and the dedent is partially received by the second indent when the container is partially removed from the cooking chamber.

In some aspects, the techniques described herein relate to a device, wherein a microswitch is positioned on the rail and configured to be engaged by the projection of the container when the container is fully inserted into the cooking chamber.

In some aspects, the techniques described herein relate to a device, wherein the container is configured to be fully removable from the cooking chamber without the dedent being received by the second indent.

Accordingly, there is a need for cooking systems that include the speed and efficiency of a microwave, while also creating an adequate Maillard reaction on a food product.

### DESCRIPTION OF DRAWINGS

These and other features will be more readily understood from the following detailed description taken in conjunction with the accompanying drawings, in which:

FIG. 1 is a front perspective view of an embodiment of a cooking system according to the subject matter described herein;

FIG. 2 is a rear perspective view of the cooking system of FIG. 1;

FIG. 3 is a front perspective view of the cooking system of FIG. 1 with a door open;

FIG. 4 is a cross-sectional view of the cooking system in FIG. 1;

FIG. 5 is a cross-sectional side view of the cooking system in FIG. 1;

FIG. 6 is a perspective view of a wave guide and mode stirrer within the cooking system of FIG. 1;

FIG. 7 is a cross-sectional top view of the cooking system in FIG. 1;

FIG. 8 is a perspective view of an outlet of the wave guide of FIG. 6 with the mode stirrer removed;

FIG. 9 is a front perspective view of the cooking system of FIG. 1 with a side panel removed;

FIG. 10 is a front perspective view of the cooking system of FIG. 1 with a top panel removed;

FIG. 11 is a front perspective view of an embodiment of a cooking container used with the cooking system of FIG. 1;

FIG. 12 is a rear perspective view of the cooking container of FIG. 11;

FIG. 13 is a side view of the cooking container of FIG. 11;

FIG. 14 is a perspective view of the cooking container of FIG. 11 partially inserted into the cooking system of FIG. 1;

FIG. 15 is a front cross-sectional view of the cooking system of FIG. 1 with the cooking container of FIG. 11 positioned therein;

FIG. 16 is a side cross-sectional view of the cooking system of FIG. 1 with the cooking container of FIG. 11 positioned therein;

FIG. 17 is a top cross-sectional view of the cooking system of FIG. 1 with the cooking container of FIG. 11 positioned therein;

FIG. 18 is a side cross-sectional view of the cooking container of FIG. 11 and a sidewall of the cooking system of FIG. 1;

FIG. 19 is a side cross-sectional view of the cooking container of FIG. 11 partially inserted into the cooking system of FIG. 1;

FIG. 20 is a detailed side view of the cooking container of FIG. 11 partially inserted into the cooking system of FIG. 1;

FIG. 21 is a top perspective view of an embodiment of a tray used with the cooking system of FIG. 1;

FIG. 22 is a perspective view of the tray of FIG. 21 partially inserted into the cooking system of FIG. 1;

FIG. 23 is a side cross-sectional view of the cooking system of FIG. 1 with the tray of FIG. 21 partially inserted;

FIG. 24 is a front perspective view of the cooking system of FIG. 1 with the tray of FIG. 21 positioned therein;

FIG. 25 is a cross-section perspective view of an embodiment of the opening assembly within the cooking system of FIG. 1;

FIG. 25A is an isolated perspective view of the button of the opening assembly of FIG. 25;

FIG. 26 is a cross-section side view of an embodiment of the opening assembly within the cooking system of FIG. 1;

FIG. 27 is a cross-section perspective view of an embodiment of the opening assembly within the cooking system of FIG. 1;

FIG. 28 is a cross-section side view of an embodiment of the opening assembly within the cooking system of FIG. 1;

FIG. 29 is a cross-section perspective view of an embodiment of a lock assembly within the cooking system of FIG. 1;

FIG. 30 is a cross-section perspective view of an embodiment of a lock assembly within the cooking system of FIG. 1;

FIG. 31 is perspective view of an embodiment of a front panel within the cooking system of FIG. 1 including a lock assembly;

FIG. 31A is an isolated perspective view of the button of the opening assembly of FIG. 31;

FIG. 32 is a detailed front perspective view of a slide component of an embodiment of a lock assembly;

FIG. 33 is a detailed rear perspective view of a slide component of an embodiment of a lock assembly;

FIG. 34 is a detailed rear view of an embodiment of a lock assembly positioned within the cooking system of FIG. 1;

FIG. 35 is a detailed perspective view of an embodiment of a lock assembly positioned within the cooking system of FIG. 1;

FIG. 36 is a detailed perspective view of an embodiment of a lock assembly and an embodiment of an opening assembly positioned within the cooking system of FIG. 1;

FIG. 37 is a detailed perspective view of an embodiment of a lock assembly and an embodiment of an opening assembly positioned within the cooking system of FIG. 1;

FIG. 38 is a detailed rear view of an embodiment of a lock assembly positioned within the cooking system of FIG. 1;

FIG. 39 is a detailed perspective view of an embodiment of a lock assembly positioned within the cooking system of FIG. 1;

FIG. 40 is a detailed perspective view of an embodiment of a lock assembly and an embodiment of an opening assembly positioned within the cooking system of FIG. 1;

FIG. 41 is a detailed perspective view of a housing including an embodiment of an opening assembly and an embodiment of a lock assembly positioned within the cooking system of FIG. 1;

FIG. 42 is a detailed rear view of a housing including an embodiment of an opening assembly and an embodiment of a lock assembly positioned within the cooking system of FIG. 1;

FIG. 43 is a detailed perspective view of a housing including an embodiment of an opening assembly and an embodiment of a lock assembly positioned within the cooking system of FIG. 1;

FIG. 43A is an isolated perspective view of the button of the opening assembly of FIG. 43;

FIG. 44 is a detailed perspective view of an embodiment of a release button positioned on a front panel;

FIG. 45 is a detailed perspective view of an embodiment of a release button positioned on a front panel;

FIG. 46 is a detailed front view of a housing including an embodiment of an opening assembly and an embodiment of a lock assembly positioned within the cooking system of FIG. 1;

FIG. 47 is a detailed perspective view of a housing including an embodiment of an opening assembly and an embodiment of a lock assembly positioned within the cooking system of FIG. 1;

FIG. 48 is a detailed front view of a housing including an embodiment of an opening assembly and an embodiment of a lock assembly positioned within the cooking system of FIG. 1;

FIG. 49 is a detailed perspective view of a housing including an embodiment of an opening assembly and an embodiment of a lock assembly positioned within the cooking system of FIG. 1;

FIG. 50 is a detailed perspective view of a housing including an embodiment of an opening assembly and an embodiment of a lock assembly positioned within the cooking system of FIG. 1;

FIG. 51 is a detailed perspective view of a housing including an embodiment of an opening assembly and an embodiment of a lock assembly positioned within the cooking system of FIG. 1;

FIG. 52 is a perspective view of an embodiment of a button contained within the housing of the cooking system of FIG. 1;

FIG. 53 is a cross-section view of an embodiment of the cooking chamber contained within the cooking system of FIG. 1;

FIG. 54 is a cross-section detailed perspective view of a microswitch positioned within a cooking chamber;

FIG. 55 is a front perspective view of an embodiment of a tray used within the cooking system of FIG. 1;

FIG. 56 is a perspective view of the tray of FIG. 55 positioned within the container of FIG. 11;

FIG. 57 is a perspective view of the tray of FIG. 55 positioned within the container of FIG. 11;

FIG. 58 is a rear perspective view of an embodiment of the cooking system of FIG. 1;

FIG. 59 is a cross-section perspective view of an upper chamber of an embodiment of the cooking system of FIG. 1;

FIG. 60 is a cross-section perspective view of an upper chamber of an embodiment of the cooking system of FIG. 1; and

FIG. 61 is a cross-section detailed perspective view of an upper chamber of an embodiment of the cooking system of FIG. 1.

It is noted that the drawings are not necessarily to scale. The drawings are intended to depict only typical aspects of the subject matter disclosed herein, and therefore should not be considered as limiting the scope of the disclosure.

### DETAILED DESCRIPTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

Traditional countertop cooking systems such as air fryers typically consist of a heating element and a fan positioned overtop of a cooking cavity. These types of cooking devices can take a relatively long amount of time to cook or reheat food due to the slow nature of convective heat exchange. Microwaves can be used to cook or reheat food relatively quickly due to the absorption of microwaves by the food, causing a generation of steam within the food. However, microwaves can leave food soggy and moist due to the condensed steam remaining on and in the food after a cooking process. Although the basic function of a microwave oven is to heat food by dielectric heating (i.e., via directly acting microwaves absorbed in the food), this disclosure includes microwave ovens that include additional kinds of cooking capabilities, such as a crisp (or browning) function or a grill function, thereby enabling preparation of various types of food items and providing new culinary effects. Such additional kinds of cooking capabilities usually require additional components such as a browning plate or a grill element.

Embodiments of the cooking systems and methods described herein advantageously provide a system that can reheat and/or cook quickly using microwaves, while also providing a crisping and browning feature to remove generated water vapor from food due to the microwaving process to create a more desirable finished food product.

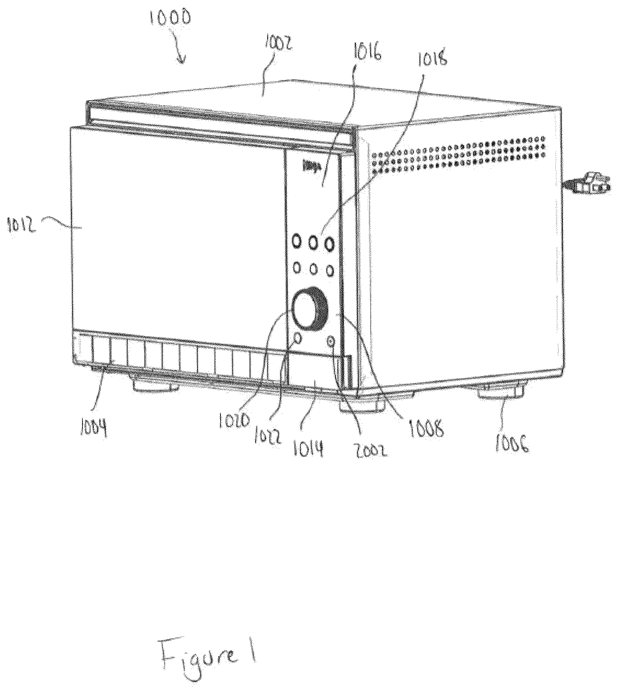

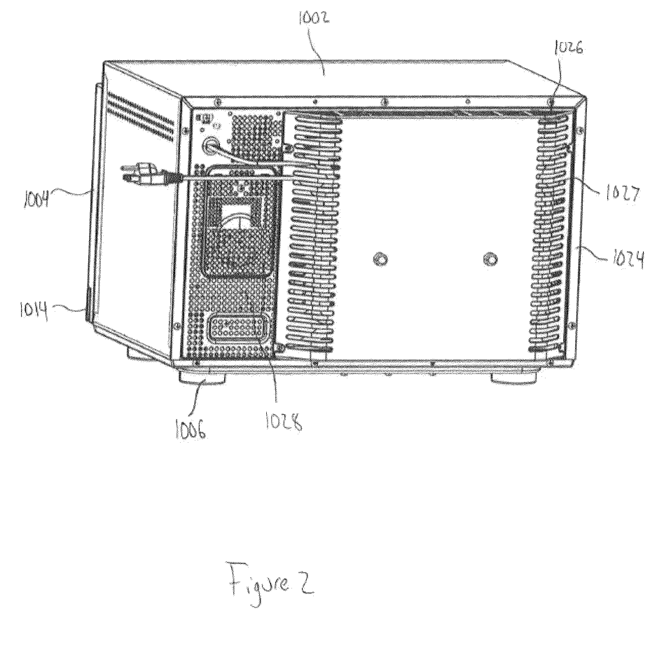

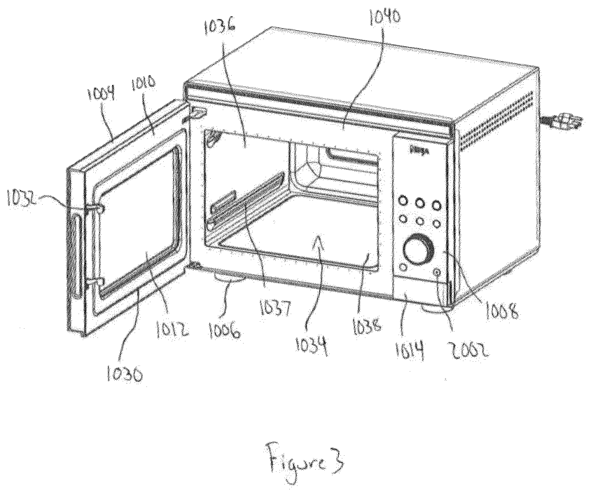

FIGS. 1-5 depict a cooking system 1000 according to the subject matter described herein. In some aspects, the cooking system 1000 can include a housing 1002 that includes a door 1004, legs 1006, and a control panel 1008. The housing 1002 can be formed from exterior panels connected together to form a rectangular-shaped box that includes a cooking chamber 1034 therein. The front panel 1040 includes a rectangular opening configured to allow a user to access the cooking chamber 1034. A rear panel 1024 of the housing 1002 includes exhaust vents 1026 positioned at the top of the rear panel 1024, exhaust vents 1027 positioned on the back of the rear panel 1024, and exhaust vents 1028 positioned at the side of the rear panel. The position of the exhaust vents 1026, 1028 corresponds to electrical and heating elements contained within the housing 1002, which will be discussed in greater detail below. The exhaust vents 1026, 1027, 1028 can include a plurality of apertures passing through the rear panel 1024.

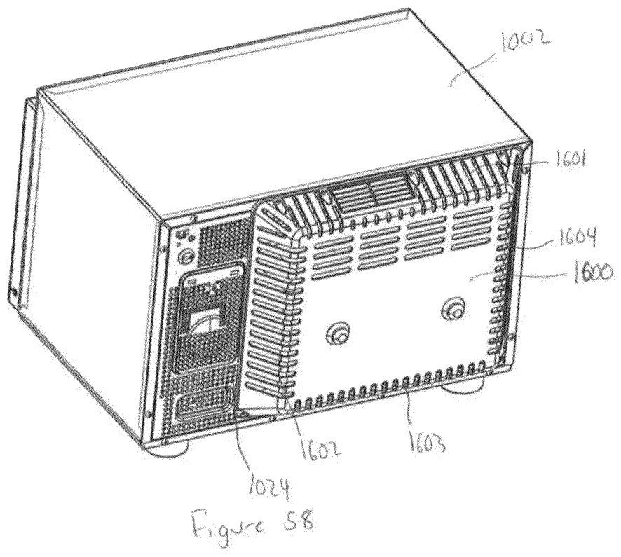

As depicted in FIG. 58, in an aspect, a second rear panel 1600 can be positioned behind, and fastened to the rear panel 1024. The second rear panel 1600 includes vents 1601, 1602, 1603, 1604, which include a plurality of apertures. The vents are positioned along the top, sides, and bottom of the second rear panel 1600. The second rear panel 1600 can act as a heat guard to prevent users from contacting a hot surface, while allowing heat to effectively leave the cooking system 1000 through the vents.

The housing 1002 can be supported on a support surface via the legs 1006. The legs 1006 extend from the bottom surface of the housing 1002 and provide an air gap between the support surface and the housing 1002. The air gap can be an insulating gap between the bottom surface of the housing 1002 and the support surface and can reduce heat transfer to the support surface during a cooking operation. The legs 1006 can be cylindrically-shaped and be positioned within proximity to the corners of the housing 1002.

The door 1004 can be movably and rotatably connected to the housing 1002 in order to selectively close the opening to the cooking volume 1034. The door 1010 can be rectangular in shape and is sized to correspond to the size of the opening into the cooking chamber 1034. The door 1004 can be connected to the side edge of the housing 1002 via a hinge system. The door 1004 includes a frame 1010 and a transparent sheet 1012. The frame 1010 supports the transparent sheet 1012, which allows a user to observe food product within the cooking chamber 1034 during a cooking process. A seal 1030 can be positioned on the inner surface of the frame 1010 and can be configured to contact and seal to the front wall 1040 of the housing 1002. Positioned on the door 1010 are latches 1032 that extend outward from the door 1010. The latches 1032 are configured to pass through apertures in the front wall 1040 and selectively connect to corresponding latch features contained within the housing 1002. The latches 1032 are designed to keep the door 1004 closed during a cooking process. A release button 1014 is positioned on the outside of the housing 1002 for a user to actuate to release the latches 1032 on the door 1010 from the housing 1002.

A control panel 1008 is positioned on the front of the housing 1002. In an aspect, the control panel 1008 is positioned adjacent to the door 1004 in a side-by-side configuration. The control panel 1008 can include a display 1016, input buttons 1018, a lock button 2002, an input button 1022, and an input dial 1020. A user can use the inputs to control the heating elements and cooking processes occurring within the cooking chamber 1034. The display 1016 can be configured to provide visual and audio feedback to a user during preparation for or during a cooking process. For example, the display 1016 can inform a user to place a container within the cooking volume to a specific position within the cooking volume for a specific cooking procedure (i.e., placing the container in proximity to forced convection heating elements). The inputs 1018, 1020, 1022 are communicatively connected to a control unit (not shown) that is also connected to the heating elements, air movement devices, and mode stirrer within the housing 1002, which will be described in greater detail below. The inputs can be used to allow a user to input specific cooking procedures, or a combination cooking procedure. In an aspect, a user can select both a microwave cooking process and an air frying cooking process using a single input from the control panel. The combination cooking process would alternate microwave cooking and forced convection cooking in order to both quickly cook an item, while also producing an appropriate Maillard reaction in the food.

In an aspect, the cooking system 1000 can perform multiple variations of combination cooking processes. For example, a user can select for a period of microwave cooking followed by a period of air frying. Such a process is beneficial for several reasons such as speeding up the defrosting process of a food item then immediately air frying the food item to cook it right after defrosting is complete. A user may also select for a period of air frying followed by a period of microwaving. A user may further select a period of microwaving, followed by a period of air frying, followed by a period of microwaving. Such a process can be beneficial for retaining heat in a food item that has been cooked to a desired state. A user may select any combination of cooking cycles between microwaving and air frying, or air frying and microwaving for as many cycles as they would like, and for any duration of time for each cycle.

In an aspect, sensors can be positioned in the cooking system 1000 that can weigh the food product being inserted into the cooking system 1000. Accounting for the weight of the food product, the cooking system 1000 can adjust the cooking time, or the cooking cycles described above to aid in obtaining a desired cooking effect on the food product and easing the user experience.

In an aspect, a camera can be positioned in the cooking system 1000. The camera can identify food products, for example beef, chicken, fish, etc., and estimate the weight of the food product. Identification of the weight and type of food product allows the system to adjust the cooking time, or the cooking cycles described above to aid in obtaining a desired cooking effect on the food product and easing the user experience. The camera can also detect the state of the food product during the cooking process, such as the crispiness of the outside of the product or if cheese has fully melted on the cooking product, then respond to the detection by adjusting or stopping the cooking time or type or alerting the user to further aid the user in obtaining a desired cooking effect on the food product. The user can also access the camera feed through a smart device to observe the state of the food product, thereby assisting the user to achieve the desired cooking effect on the food product.

In an aspect, a mobile application can be used in conjunction with the cooking system. Food products can be packaged with a scannable barcode. A user can scan the barcode and access recipes and instructions for cooking that food product in the cooking system. The instructions associated with the bar code can include time criteria and criteria for cycling the cooking mode as described above. Additionally, a user may photograph their own food product and upload the photograph with instructions for obtaining the same food product such as recipes and the cooking mode cycle and time criteria.

The cooking chamber 1034 is configured to receive food product for a cooking process. The cooking chamber 1034 includes sidewalls 1036, 1042, a bottom wall 1038, a top wall 1044, and a rear wall 1046. The door 1004 forms the final side of the cooking chamber 1034 when in a closed position, sealing the cooking chamber 1034 for a cooking process. The bottom wall 1038 separates the cooking chamber 1034 from a lower chamber 1039. In an aspect, the bottom wall is formed from a mica sheet, which allows microwaves to pass from the lower chamber 1039 into the cooking chamber 1034. The top wall 1044 separates the cooking chamber 1034 from an upper chamber 1062. In an aspect, the top wall 1044 can include a plurality of apertures that allows heated air to pass through the top wall 1044 and into the cooking chamber 1034 during a forced convection cooking process (i.e., air frying). In an aspect, the top wall 1044 can include a rib extending downward into the cooking chamber 1034. The rib can be positioned at the front of the cooking chamber 1034, the middle, or the rear, and extend across the width or partially across the width of the cooking chamber 1034. The rib is designed to reduce the gap between the top wall 1044 and the container 1100 when the container is inserted into the upper air frying position within the cooking chamber 1034. The rib can reduce heat loss during an air frying process, and increases the efficiency of the air frying process.

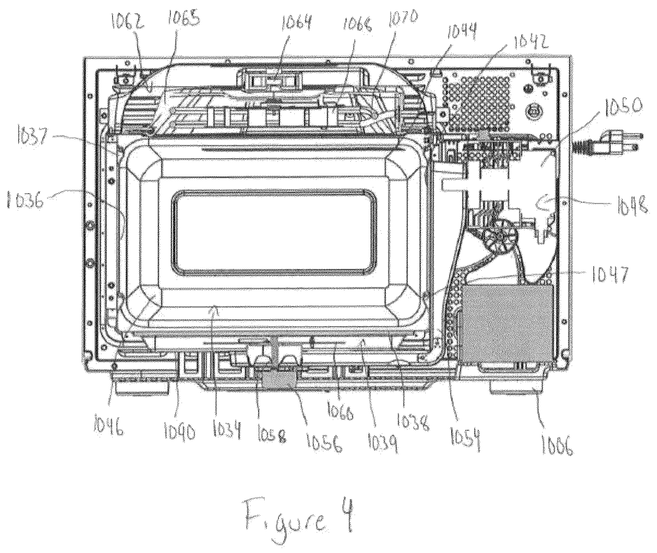

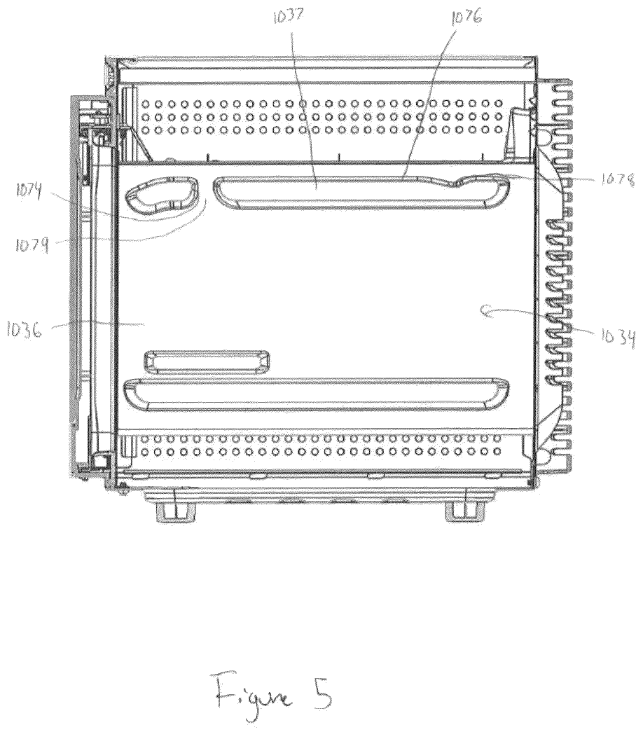

As illustrated in FIGS. 4-5, the sidewall 1036 includes rails 1037, and the sidewall 1042 includes rails 1047. The rails 1037, 1047 are formed in the sidewalls 1036, 1042 through a stamping process which integrally forms the rails 1037, 1047 into the sidewalls 1036, 1042. The rails 1037, 1047 extend from the rear of the cooking chamber 1034 to the front of the cooking chamber 1034. In an aspect, the rails 1037, 1047 include a top edge 1076, which contacts a tray or container being used within the cooking chamber 1034. The sidewalls 1036, 1042 can include a plurality of similarly shaped rails along different heights within the cooking chamber 1034. In an aspect, the rail 1037 further includes a channel 1078. The channel 1078 creates a curved edge along the top edge 1076. The rails 1037 can include a second channel 1079 extending through the rails 1037 such that a gap is formed and the rails 1037 are split into two sections. The rails 1047 have similar features as those described with respect to the rails 1037.

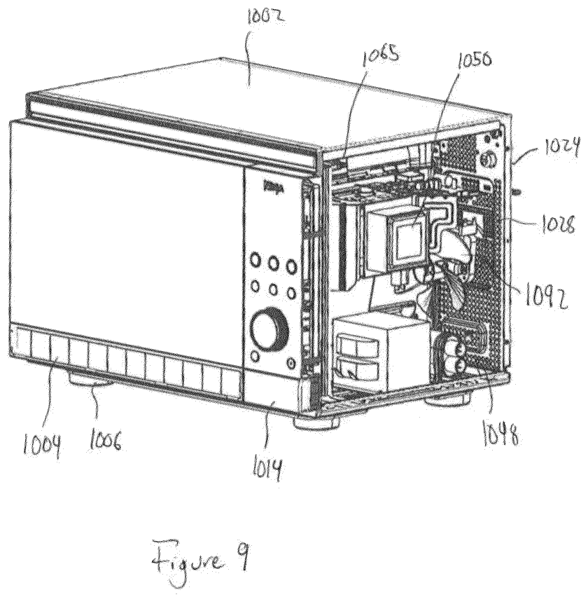

A side chamber 1048 is positioned adjacent to the cooking chamber 1034. The side chamber 1048 extends from the bottom to the top of the housing 1002, and from the front to the back of the housing 1002. The side chamber 1048 houses a majority of the electrical components, including the magnetron 1050 for producing microwaves. As illustrated in FIG. 9, the side chamber 1048 includes a cooling fan 1092, which is positioned adjacent to the exhaust vents 1028 in the rear panel 1024 of the housing 1002. The cooling fan 1092 is configured to draw hot air from the magnetron 1050 and electrical components in the side chamber 1048 and expel the hot air through the exhaust vents 1028. Also positioned in the side chamber 1048 is a wave guide 1054 for directing microwaves produced by the magnetron 1050 into the cooking chamber 1034. In an aspect, the fans 1068, 1092 can run at all times during a cooking process, regardless of if the cooking process is a microwave cooking process, a convection cooking process, or a combination of both. This ensures that the temperature within the cooking system 1000 remains within a threshold limit for the electronics therein.

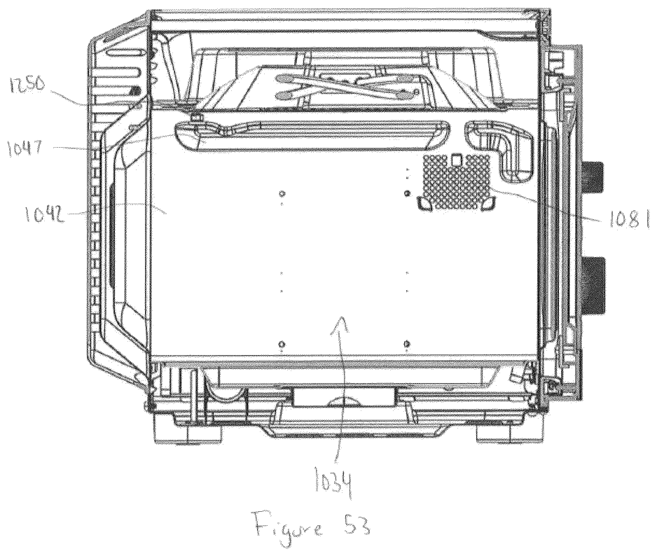

As depicted in FIG. 53, in an aspect, a vent 1081 including a plurality of apertures can be located on the sidewall 1042. The vent 1081 allows air to pass from the cooking chamber 1034 through the side wall 1042 to the side chamber 1048. The air moving from the cooking chamber 1034 to the side chamber 1048 flows around the magnetron 1050 to further cool the magnetron 1050.

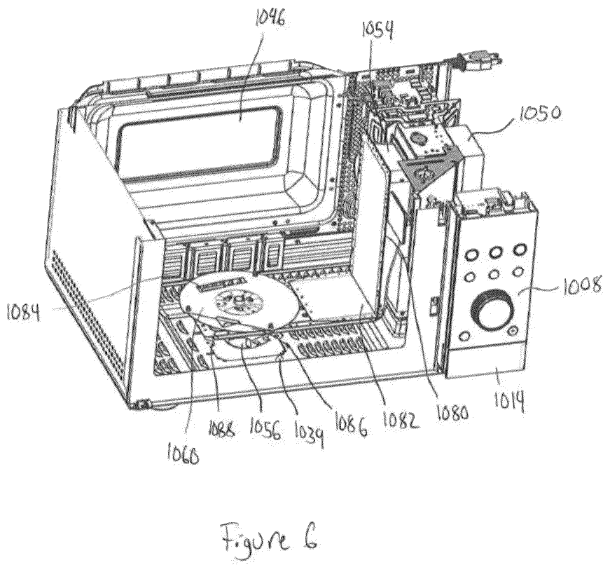

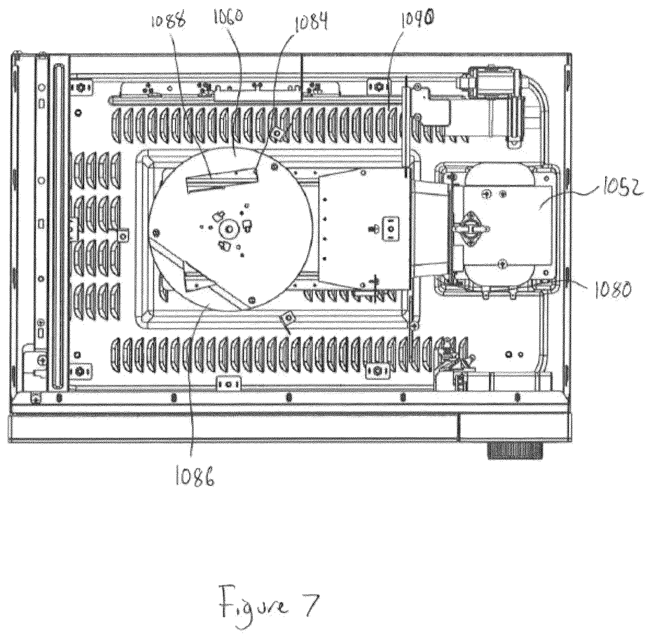

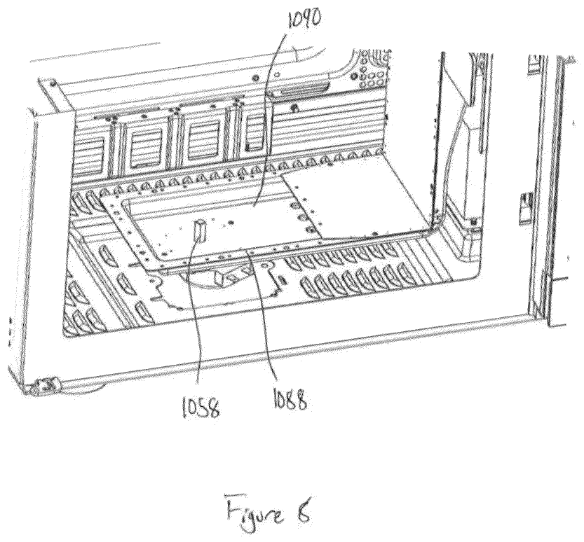

As illustrated in FIGS. 6-8, the wave guide 1054 extends from the side chamber 1048 to the lower chamber 1039. The wave guide includes a vertical section 1080, and a horizontal section 1082. The vertical section 1080 includes an inlet configured to receive microwaves produced by the magnetron 1050. The microwaves travel down the vertical section 1080, and then pass into the horizontal section 1082. The wave guide 1054 is formed from a microwave blocking material, such as metal, to guide the microwaves without allowing them to emit from the wave guide except at an outlet 1088. The outlet 1088 is positioned in the horizontal section 1082 to emit the microwaves from the wave guide 1054 into the lower chamber 1039.

The lower chamber 1039 is positioned vertically below the cooking chamber 1034 and is defined by the lower wall 1038 and a radiation shield 1090. A mode stirrer 1060 is positioned within the lower chamber 1039 and is configured to interact with the microwaves being emitted from the outlet 1088. The radiation shield 1090 reflects the microwaves upward from the lower chamber 1039, through the lower wall 1038, and into the cooking chamber 1034.

The mode stirrer 1060 includes a rotating body that deflects the microwaves being emitted from the outlet 1088. The mode stirrer 1060 is positioned vertically above the outlet 1088. In an aspect, the mode stirrer 1060 is a substantially circular disk formed of metal that includes features to help further deflect microwaves. These features include apertures 1084 and a projection 1086. The apertures 1084 can be rectangular in shape and can be asymmetrical on the mode stirrer 1060. The projection 1086 is a raised portion of the mode stirrer 1060. The mode stirrer is rotated via a motor 1056 positioned vertically underneath the lower chamber 1039. In an aspect, the motor 1056 is a BLDC motor with a reduce vertical profile. A driveshaft 1058 of the motor 1056 passes upward through the radiation shield 1090 and connects to the mode stirrer 1060. As the mode stirrer 1060 rotates, microwaves being emitted from the outlet 1088 are scattered about the cooking chamber 1034. Due to the asymmetrical design of the mode stirrer 1060, the microwaves are scattered in a random pattern about the cooking chamber 1034, leading to a more even cooking of a food product within the cooking chamber 1034.

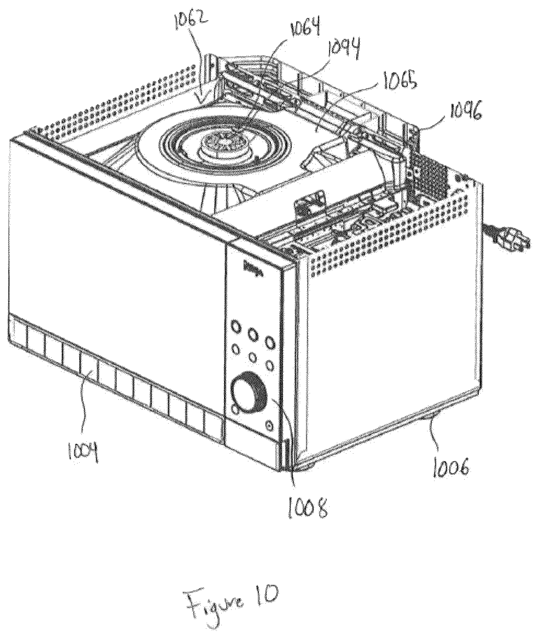

The upper chamber 1062 is formed within the housing 1002 to include the forced convection cooking elements which complement the microwave cooking elements during a combination cooking process. The upper chamber 1062 is defined by the top wall 1044 and a radiation shield 1065. As illustrated in FIG. 10, the radiation shield 1065 can include an outlet 1096 connected to the exhaust vents 1026 on the rear wall 1024 of the housing 1002. Additionally, the exhaust vents 1027 exhaust air from the upper chamber 1062. A heating element 1070 is positioned within the radiation shield 1065 and configured to emit heat energy to heat a forced airflow over the heating element 1070. In an aspect, the heating element 1070 is a cal-rod, carbon fiber heating element, quartz heating, or any other suitable heating element. An air movement device 1068 is positioned radially inward of the heating element 1070 within the radiation shield 1065. The air movement device 1068 can be a centrifugal fan that directs air radially outward across the heating element 1070. A motor 1064 is positioned vertically above the radiation shield 1065 and includes a driveshaft 1066 extending downward through the radiation shield to connect to the air movement device 1068. The air movement device 1068 is rotated via the motor 1064, which can be a BLDC motor with a reduced vertical profile.

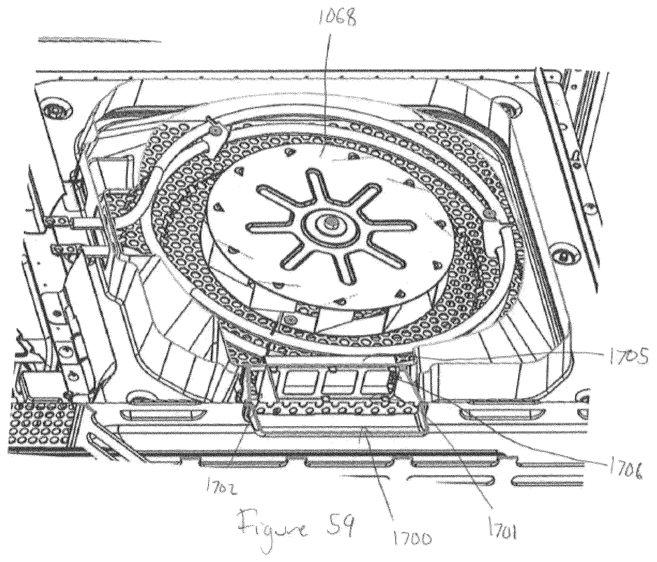

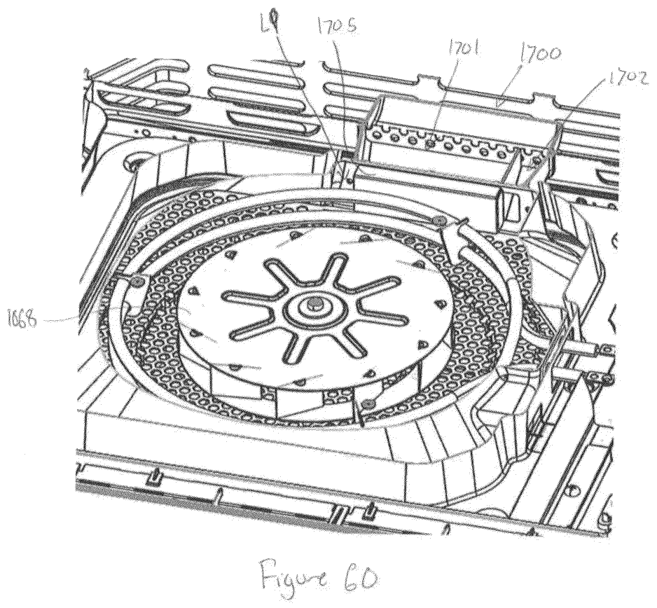

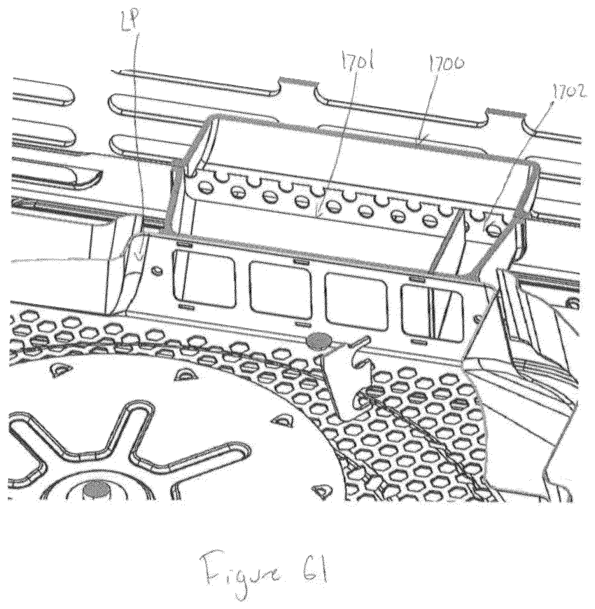

As depicted by FIGS. 59-61, in an aspect, an opening 1700 can be positioned between the rear panel 1024 and the upper chamber 1062 that includes an air inlet 1701 and an air outlet 1702. The opening 1700 includes a wall to split the opening into the inlet 1701 and the outlet 1702. The surface area of the inlet 1701 can be 8-9 times larger than the surface area of the outlet 1702. The inlet 1701 can be formed of a single opening or multiple openings, such as a series of slotted openings or a screen. A venturi baffle 1705 is positioned in front of the inlet 1701, between the inlet 1701 and the upper chamber 1062. In an aspect, when the air movement device 1068 is actuated to move in a counterclockwise direction air is pulled through the inlet 1701 and redirected by the venturi baffle 1705 through an entry point 1706. The entry point 1706 is smaller than the inlet 1701 such that when the venturi baffle 1705 redirects the air through the entry point 1706 a low-pressure point LP is created. The low-pressure point LP further aids in pulling air into the upper chamber 1062. Due to the configuration of the outlet 1702 and the counterclockwise rotation of the air movement device 1068, as air circulates the upper chamber 1062 some of the air is expelled through the outlet 1072.

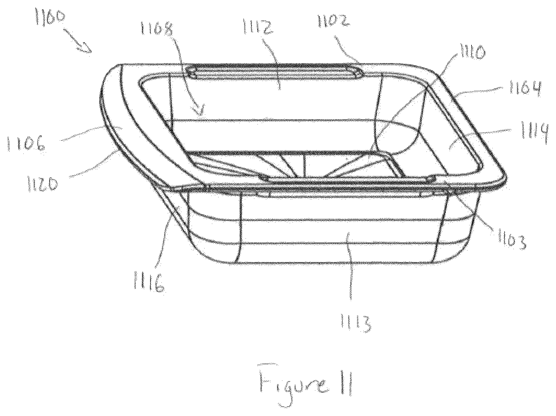

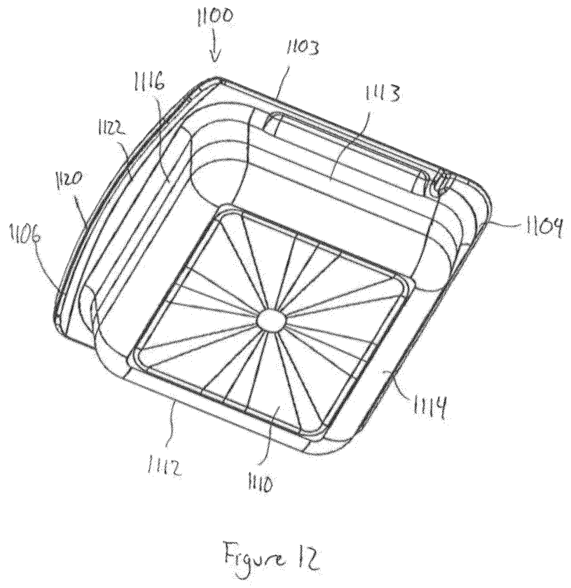

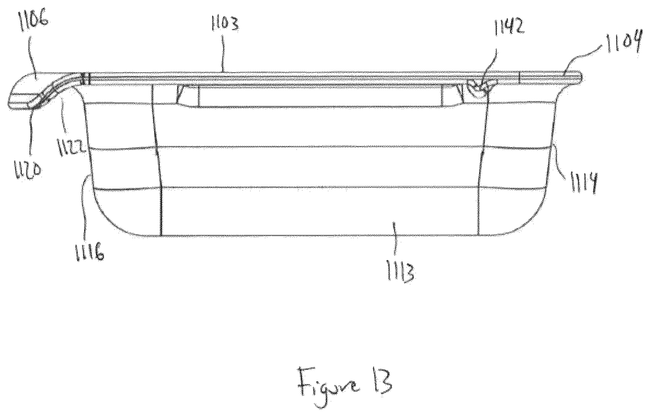

While a food product can be placed anywhere within the cooking chamber 1034 for a microwave cooking process, it is beneficial to reduce the size of the cooking volume during a forced convection cooking process. In order to create a sub-cooking volume within the cooking chamber 1034, a separate cooking container can be used. FIGS. 11-13 depict a cooking container 1100 configured to be used within the cooking volume 1034 during a forced convection cooking process. The cooking container 1100 can also be used during a microwave cooking process since the container is made from a non-microwave blocking material, such as glass or plastic.

The container 1100 includes side tabs 1102, 1103 arranged on opposite sides of the container 1100, and extending from the rear of the container 1100 to the front of the container 1100. A rear lip 1104 is formed along a rear edge of the container. A front lip 1106 is formed along the front edge of the container 1100 and includes a handle 1120 and grip channel 1122 for a user to easily grab and handle the container 1100. In an aspect, the handle 1120 can include a cool-touch surface in the form of an insulated handle. A cooking volume 1108 is formed in the container 1100, and is defined by sidewalls 1112, 1113, 1114, 1116, and bottom wall 1110. The bottom wall 1110 can include a plurality of apertures. The container 1100 can be square or rectangular in shape and is designed to limit heat loss from the cooking volume 1108 into the cooking chamber 1034 during a forced convection cooking process. The container 1110 includes protrusions 1142, 1143 that extend from the side tabs 1102 and 1103 respectively. The protrusions 1142, 1143 can be shaped substantially similar to the channels 1078.

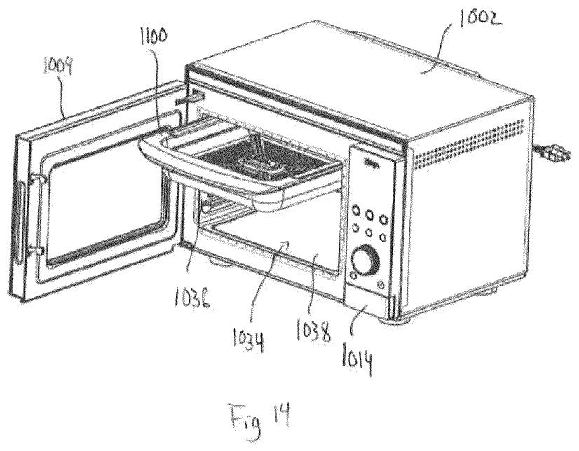

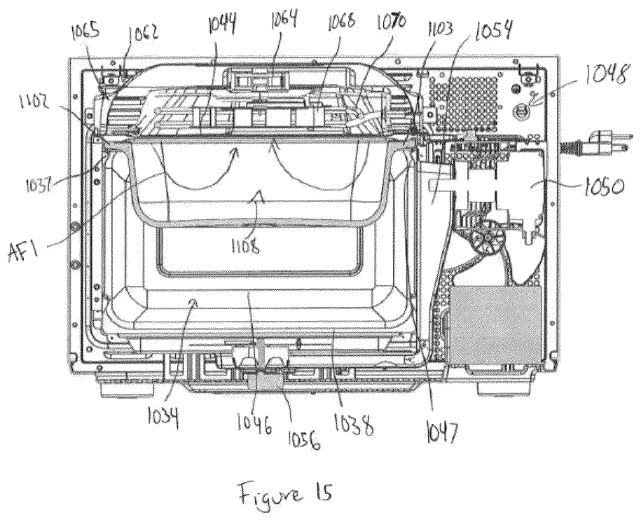

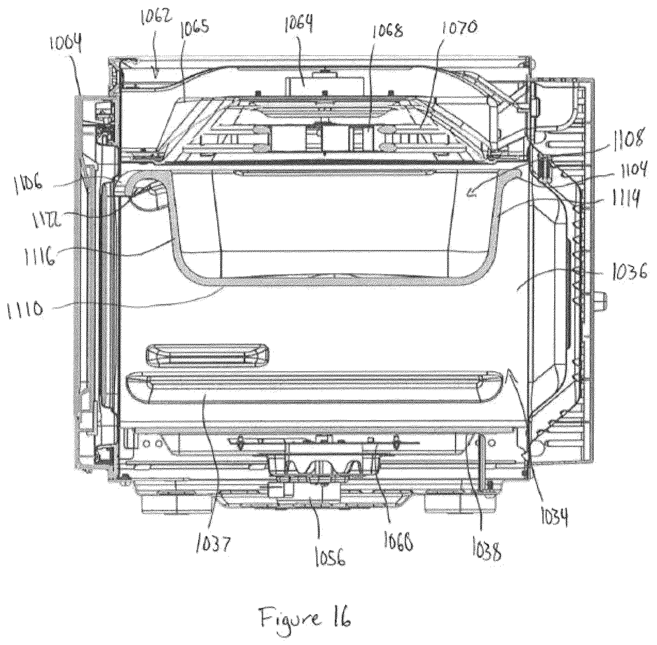

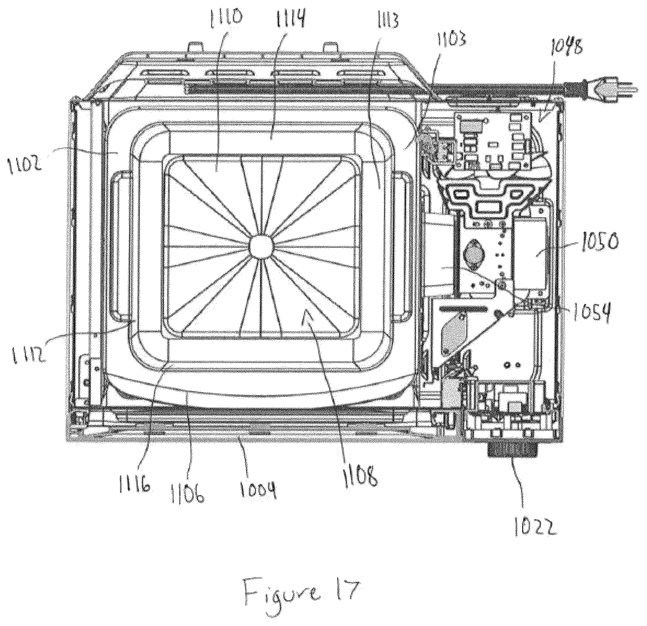

FIGS. 14-18 illustrate the container 1100 within the cooking chamber 1034. The container 1100 can be slid along the rails 1037, 1047 within the cooking chamber 1034. As shown in FIG. 17, the envelope of the container 1100 is substantially similar to the cross-sectional shape of the cooking chamber 1034. Due to this size similarity, along with the side tabs 1102, 1103 resting on the rails 1037, 1047, and the rear lip 1104 and front lip 1106 extending to the rear wall and door within the cooking chamber 1034, the upper portion of the cooking chamber 1034 is substantially sealed, which contains the heated air flow being generated by the air movement device 1068 and the heating element 1070. This greatly increases efficiency of the air frying process since there is minimal heat loss across the cooking volume 1108 compared to if the whole of the cooking chamber 1034 had to be heated by the forced convection airflow. Additionally, the radiation shield 1065 is designed such that the radiation shield deflects the heated airflow downward into the cooking volume 1008. The edge of the radiation shield that deflects the airflow is vertically aligned with the sidewalls 1112, 1113, 1114, 1116 of the container 1100. The airflow is depicted by arrows AF1, which show the torus airflow circulating through the cooking volume 1108. The container 1110 can act as a divider to reduce the air volume required to be circulated by the air movement device, increasing the efficiency of a forced convection cooking process.

In an aspect, the gap between the container 1100 and the top wall of the cooking chamber 1034 can be minimized, while maintaining a space between the container 1100 and the top wall 1044. For example, the space between the container 1100 and top wall 1044 can be 6.65 mm. Minimizing the gap between the container 1100 and the top wall of the cooking chamber 1034 reduces heat transfer from the container 1100 during the forced convection cooking process, thereby improving the efficiency of the cooking process.

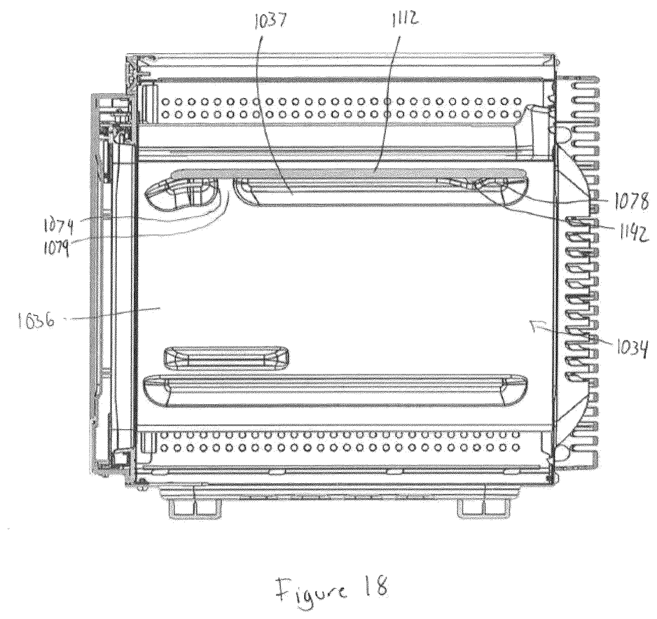

As stated above, the rail 1037 includes the channel 1078. As illustrated in FIG. 18 when the container 1100 is inserted along the rails 1037 the protrusions 1142 engage the channel 1078 stopping the container 1100 from being inserted further into the cooking chamber 1034, thereby aligning the container 1100 at a desired position within the cooking chamber 1034.

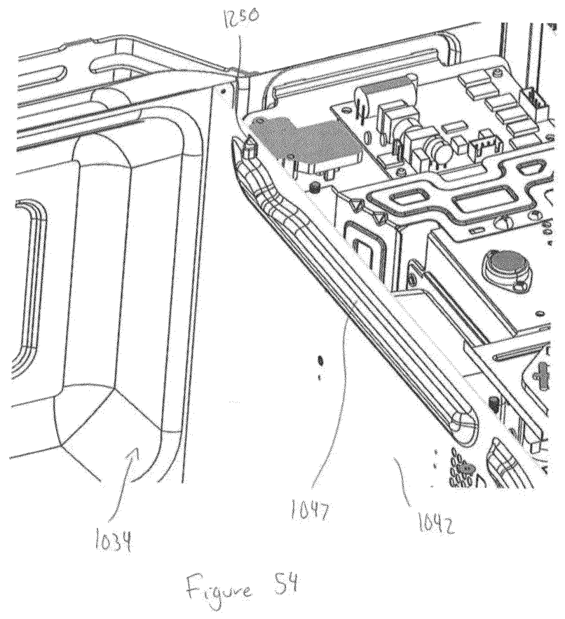

As depicted by FIGS. 53-54, in an aspect, a microswitch 1250 can be positioned above either rail 1037, 1047 at the rear of the cooking chamber 1034. The microswitch 1250 is positioned such that when the container 1100 is fully inserted into the cooking chamber 1034 the microswitch 1250 is actuated, thereby detecting that the container 1100 is fully inserted into the cooking chamber 1034. When the microswitch 1250 is actuated, it allows a user to activate the forced convection cooking process. When the microswitch 1250 is not actuated, meaning the container 1100 is not fully inserted into the cooking chamber 1034, the forced convection cooking process is deactivated, thereby preventing a user from activating the forced convection cooking process.

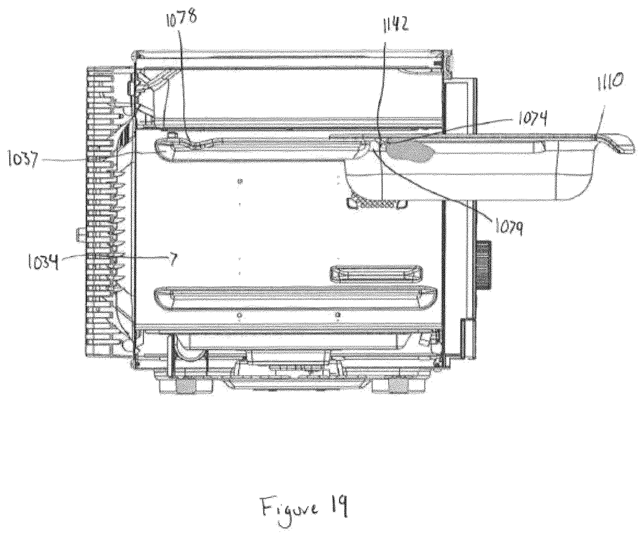

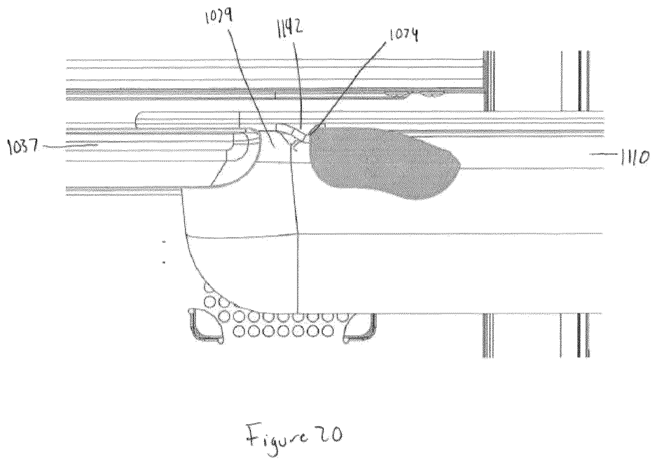

As stated above, the rail 1037 includes the channel 1079. As illustrated in FIGS. 19-20 the protrusion 1142 of the container 1100 contacts an edge 1074 of the channel 1079 in order to prevent the container 1100 from being removed from the cooking chamber 1034 unintentionally. A user must rotate the container 1100 upward to pass the protrusion 1142 over the edge 1074 to remove the container 1100 from the cooking chamber 1034.

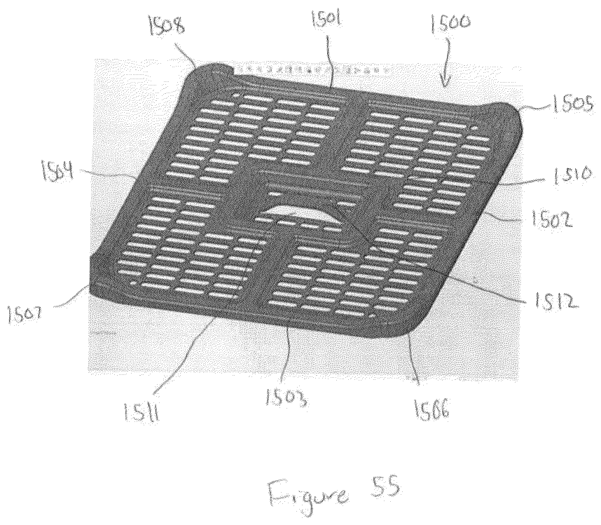

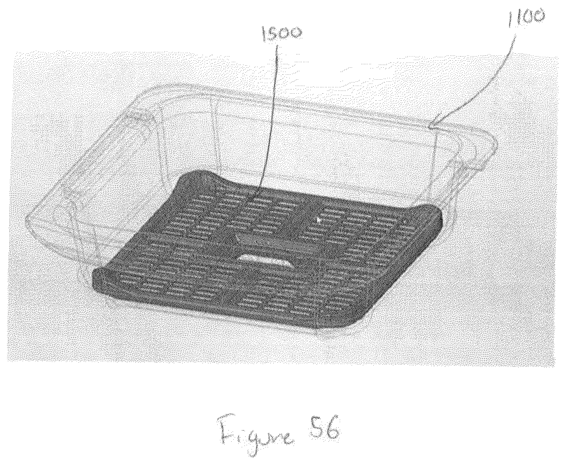

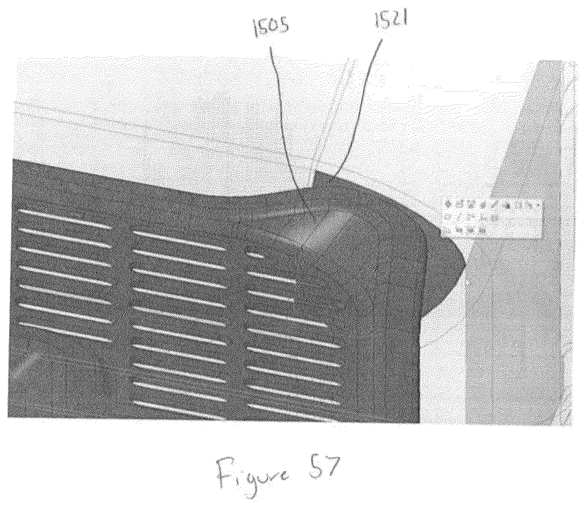

As depicted in FIGS. 55-57, in an aspect, a tray 1500 can be inserted into the cooking container 1100. The tray 1500 includes a top surface and a bottom surface. The tray 1500 is defined by sidewalls 1501, 1502, 1503, 1504 and a bottom wall 1510. The shape of the tray 1500 is substantially similar to the shape of the bottom wall 1110 such that the bottom surface can rest in the bottom of the cooking volume 1108. Corner walls 1505, 1506, 1507, 1508 integrally connect the sidewalls 1501, 1502, 1503, 1504, extend from the bottom wall 1510, and are substantially similar in shape to the shape of the bottom corners of the container 1100, further stabilizing the tray in the container 1100 when inserted. Rubber grips 1521 can be positioned on the corner walls 1505, 1506, 1507, 1508 to act as a friction contact between the tray 1500 and the container 1100, thereby helping to prevent the tray 1500 from accidentally falling out of, or accidentally being removed from the container 1100. An aperture 1511 is located in the center of the bottom wall 1510, and a projection 1512 extends above the aperture 1511 and can act as a grip for removing the tray 1500 from the container 1100. The bottom wall 1510 also includes a plurality of apertures that are ovular in shape and allow for microwaves to pass through the tray 1500. However, other shapes with rounded geometries can be used instead of an ovular shape, and should be considered within the scope of this disclosure. Rounded edges are preferred for the tray 1500 surfaces because they prevent arcing. As such the apertures in the bottom wall 1510 can be any other shape with a rounded geometry. Similarly, the other surfaces of the tray 1500 can be rounded to prevent arcing, since electric charges accumulate at sharp points, edges, or corners of metal objects. The tray 1500 is non-arcing when positioned in the container 1100 and inserted into the cooking chamber 1034 due to gaps between the tray 1500 and any metallic surface in the cooking chamber 1034 such as the sidewalls, 1036, 1042.

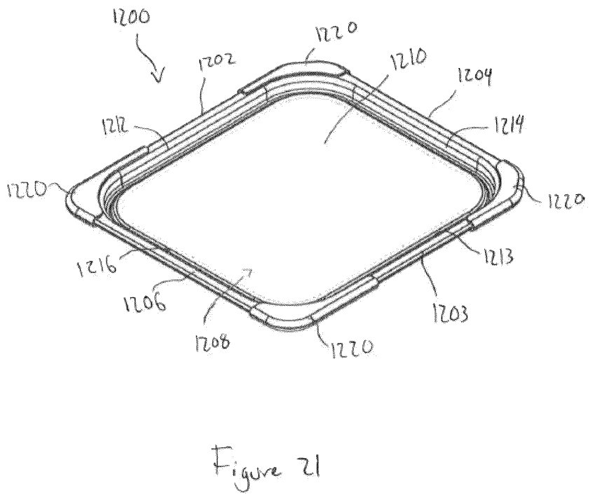

FIG. 21 illustrates a tray 1200 which is configured to be used with the cooking system 1000. The tray 1200 includes side tabs 1202, 1203 arranged on opposite sides of the tray 1200, and extending from the rear of the tray 1200 to the front of the tray 1200. A rear lip 1204 is formed along a rear edge of the tray 1200 and a front lip 1206 is formed along a front edge of the tray 1200. A cooking volume 1208 is formed in the tray 1200, and is defined by sidewalls 1212, 1213, 1214, 1216, and bottom wall 1210. The tray 1200 can be square or rectangular in shape. The tray 1200 also includes insulating bodies 1220 positioned at the corners of the tray 1200 in order to insulate the conductive portions of the tray 1200 from the conductive portion of the cooking chamber 1034. Due to the nature of microwave cooking, sparking can occur between two conductive surfaces within a microwave during a cooking process using microwaves.

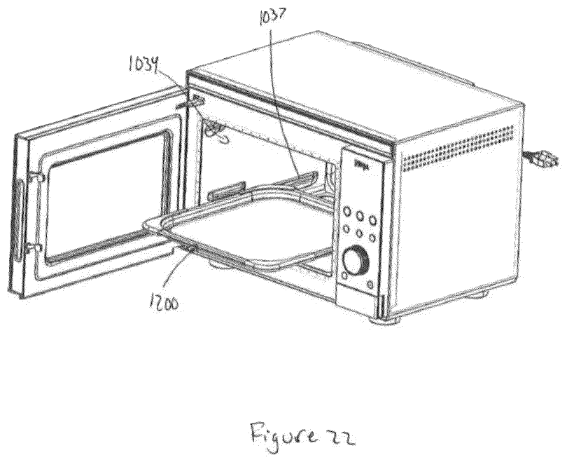

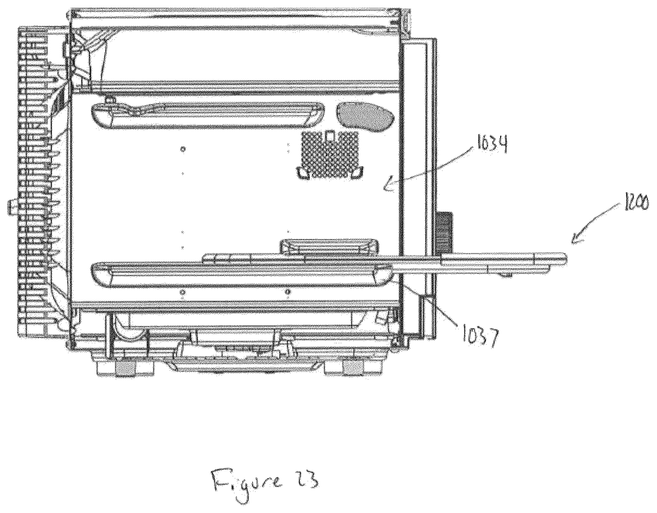

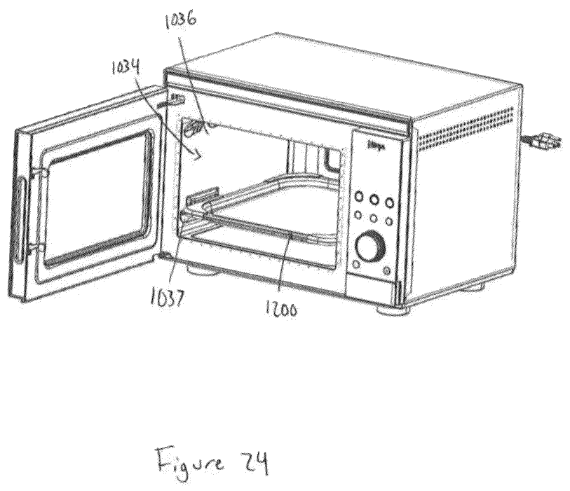

As illustrated in FIGS. 22-24, the tray 1200 can be inserted into the cooking volume 1034, and is supported by the rails 1037, 1047. The tray 1200 can be positioned at various heights within the cooking chamber 1034 using the rails 1037, 1047. In an aspect, the tray 1200 can be used to support a container within the cooking chamber 1034 and can also be used to create a dual layer cooking chamber, where multiple cooking containers can be used, with one resting on the bottom surface 1038 of the cooking chamber 1034, and one resting vertically above on the tray 1200.

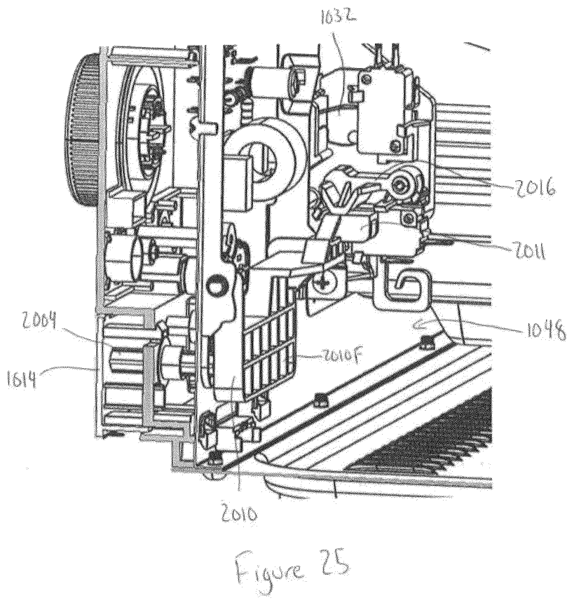

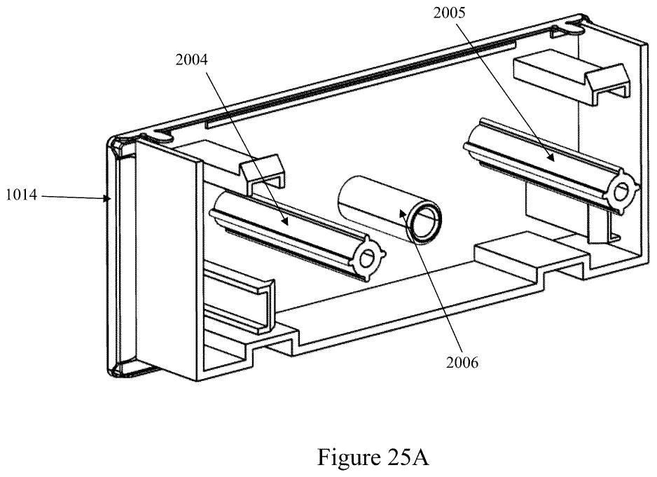

FIGS. 25-28 depict an opening assembly and lock assembly. The opening assembly can include a release button 1014, press rods 2004, 2005, an opening rod 2006, press rod springs 2014, a paddle 2010, latches 1032, and a latch release 2016. The press rods 2004, 2005 and opening rod 2006 can be cylindrically-shaped and can have a plurality of spaced protrusions disposed on an external face. The protrusions can be evenly spaced and can span the length of the press rods 2004, 2005 and opening rod 2006. The press rods 2004, 2005 and the opening rod 2006 are integrally connected to the back side of the release button 1014 such that the press rods 2004, 2005 and opening rod 2006 extend through the front panel 1040 of the housing 1002. The press rod springs 2014 are each respectively oriented around the press rods 2004, 2005 and are configured to bias the release button 1014 to a decompressed position. The paddle 2010 is rectangular in shape with a first side 2010F and a second side 2010S. A protrusion 2011 extends from the first side 2010F. The edge of the second side 2010S is rotatably connected to the internal side of the front panel 1040 of the housing 1002 in the side chamber 1048. The paddle 2010 is positioned on the opposite side of the front panel 1040 from the release button 1014. The latch release 2016 includes an arm with a protrusion extending from one end. The end of the arm opposite the protrusion is pivotally attached to the interior of the side chamber 1048. The protrusion of the latch release 2016 is positioned between the protrusion 2011 of the paddle 2010 and a latch 1032.

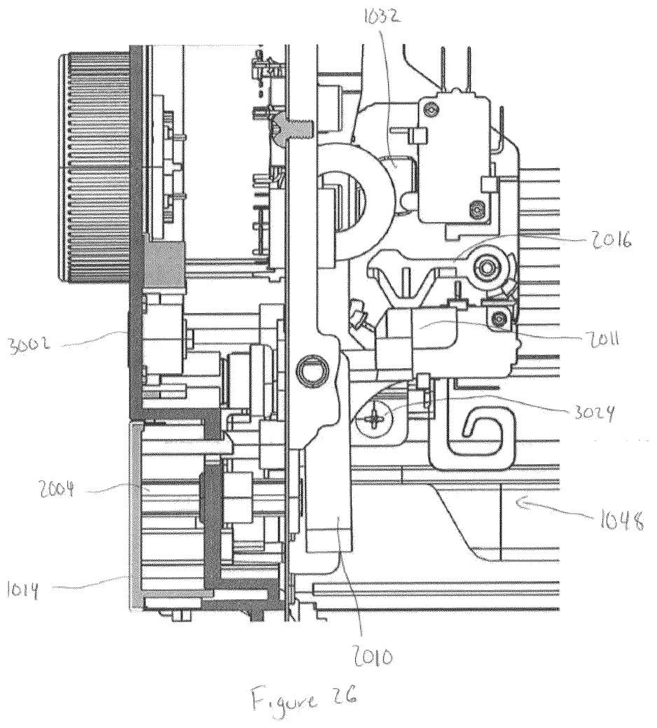

In an aspect, FIGS. 25 and 26 depict the opening assembly in a first position. In the first position, the release button 1014 is in a decompressed state. The opening rod 2006 is positioned outside of the aperture 3018 and external to the side chamber 1048. The press rods 2004 are positioned such that there is a gap between the end of the press rods 2004 and the second side 2010S of the paddle 2010. The press rod springs 2014 are decompressed. The latch release 2016 is positioned to freely engage with the protrusion 2011 of the paddle 2010 and there is a gap between the latch release 2016 and the latch 1032.

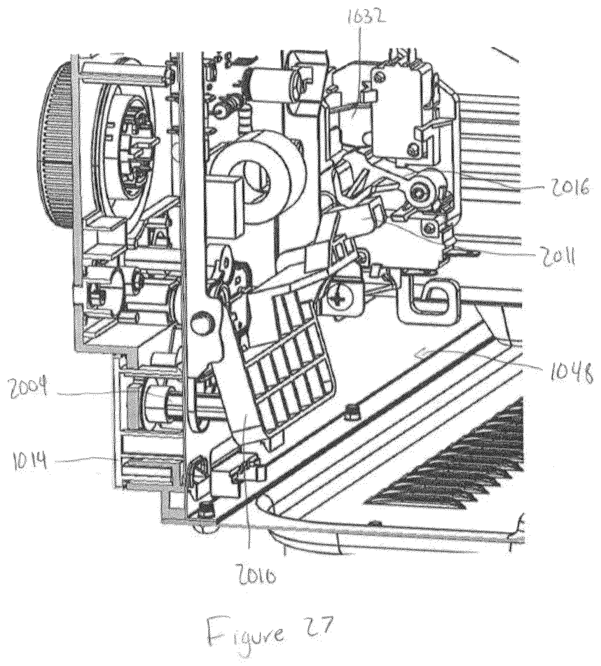

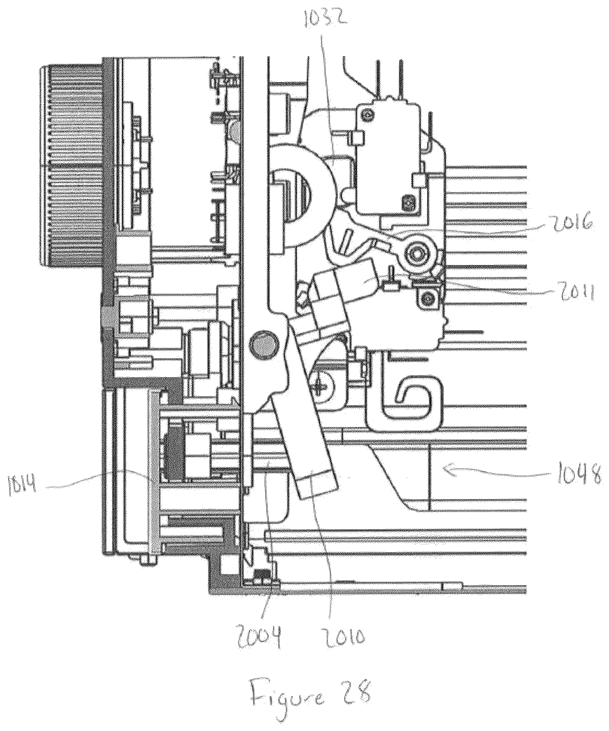

In an aspect, FIGS. 27 and 28 depict the opening assembly in a second position. In the second position, the release button 1014 is in a compressed state. The press rod springs 2014 engage with the front panel 1040 and are in a compressed state, such that when the release button 1014 is released the press rod springs 2014 will bias the release button 1014 to return to the decompressed state. The opening rod 2006 extends into the aperture 3018. The press rods 2004, 2005 extend through the front panel 1040 and into the side chamber 1048 to engage the second side 2010S of the paddle 2010. When the press rods 2004, 2005 engage the second side 2010S of the paddle 2010 they push the paddle 2010 such that the paddle is rotated by the push rods 2004, 2005. The protrusion 2011 engages the latch release 2016 to rotate the latch release 2016. The latch release 2016 engages with the latch 1032 thereby releasing the latch 1032 from a locked position. The latches 1032 are operably linked (not shown) such that when the latch release 2016 releases one latch 1032 both latches 1032 are released from a locked position and the door 1004 can be opened.

In an aspect, when the release button 1014 is pressed it moves the opening assembly from the first position to the second position.

The lock assembly can include a lock button 3002, a locking rod 3008, an aperture 3018, a motor 3020, and a switch 3024. In an aspect, the lock button 3002 is located on an external face of the control panel 1008. The lock button 3002 can be a mechanical or electrical input. The locking rod 3008 is connected to the motor 3020. The locking rod 3008 is movably positioned between the release button 1014 and the aperture 3018. The motor 3020 is mechanically or electrically linked to the lock button 3002. The aperture 3018 is positioned on the front panel 1040 and is an opening to the side chamber 1048. The aperture 3018 is large enough that the opening rod 2006 can fit through it.

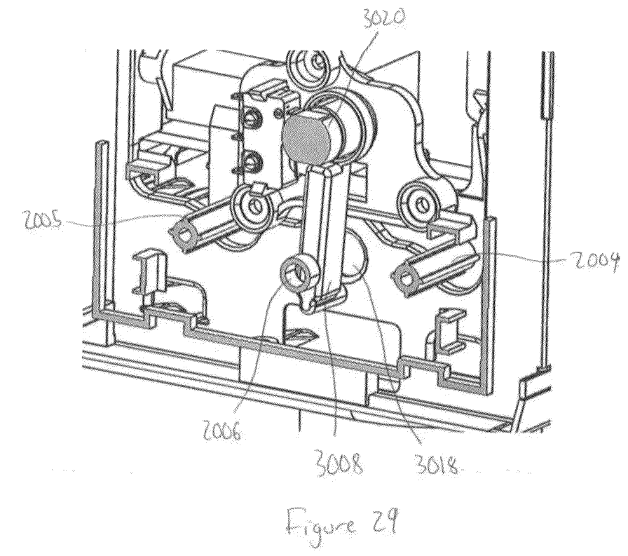

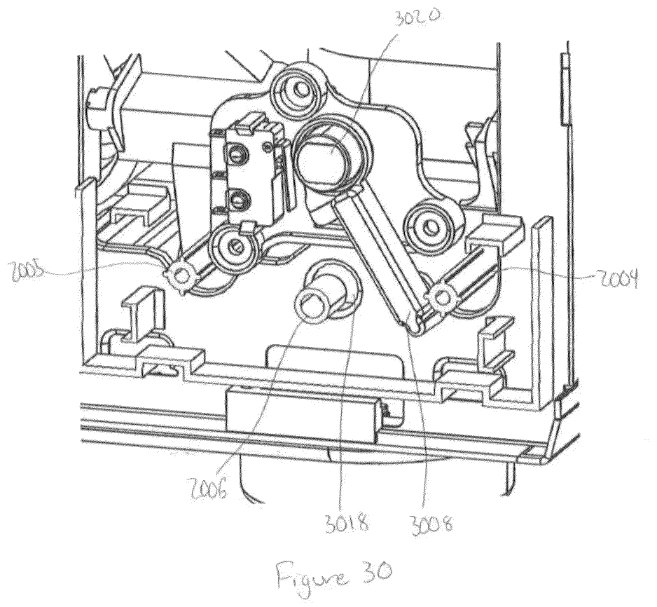

FIG. 29 depicts the lock assembly in a first position. In an aspect, the locking rod 3008 is positioned to at least partially cover the aperture 3018. FIG. 30 depicts the lock assembly in a second position. In an aspect, the locking rod 3008 is positioned such that it does not cover the aperture 3018. When the lock button 3002 is pressed it actuates the motor 3020 which rotates the locking rod 3008 between the first position and the second position. When the locking rod 3008 is in the first position it blocks the opening rod 2006 from entering the aperture 3018 (FIG. 29), thereby preventing the opening assembly from moving between the first position and the second position when the release button 1014 is pressed. In an aspect, when the locking rod 3008 is in the second position the opening rod 2006 can pass through the aperture 3018 (FIG. 30), thereby allowing the opening assembly to move between the first position and the second position when the release button 1014 is pressed thus opening the door 1004.

In an aspect, the lock assembly is biased to return to the first position, thereby requiring the lock button 3002 to be pressed for the door 1004 to be opened.

In an aspect, the switch 3024 can be actuated such that the lock assembly is locked in the second position, thereby allowing the door 1004 to be opened without the lock button 3002 being pressed.

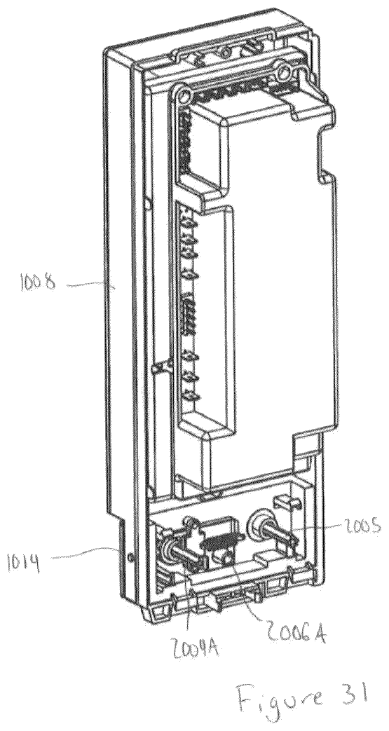

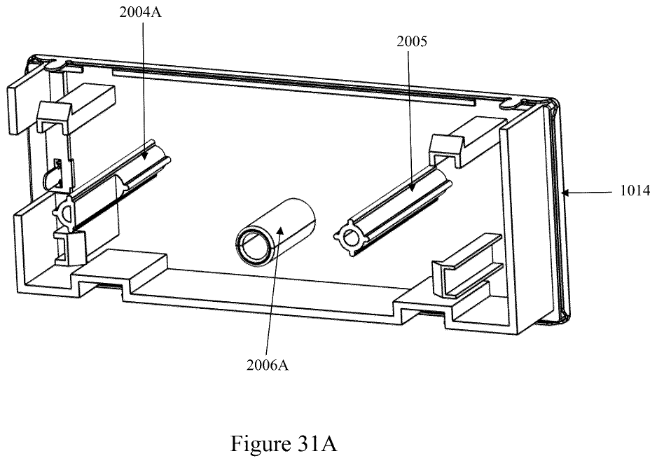

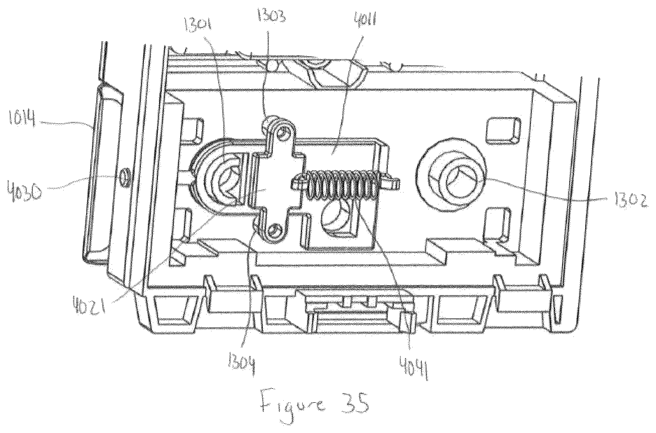

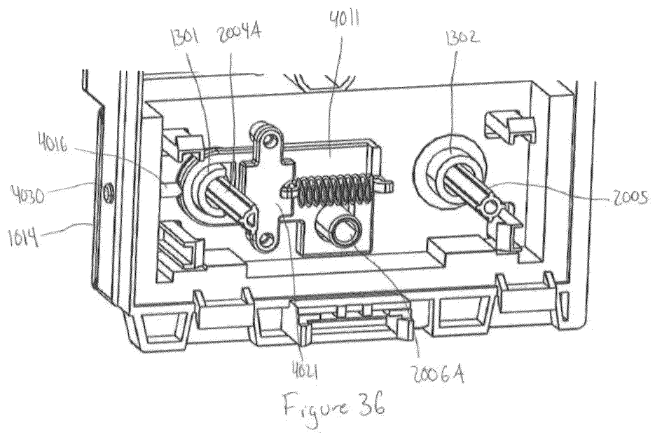

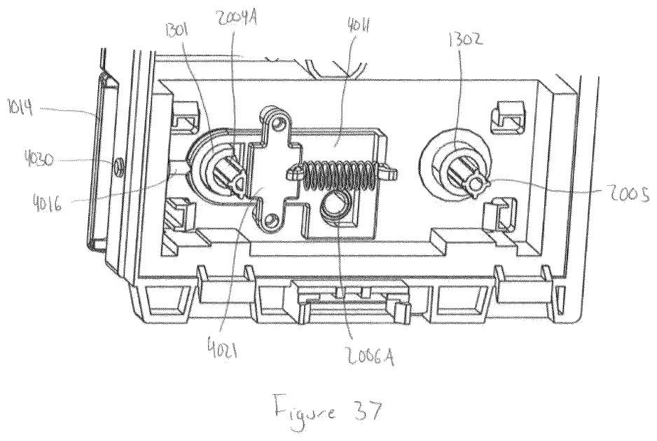

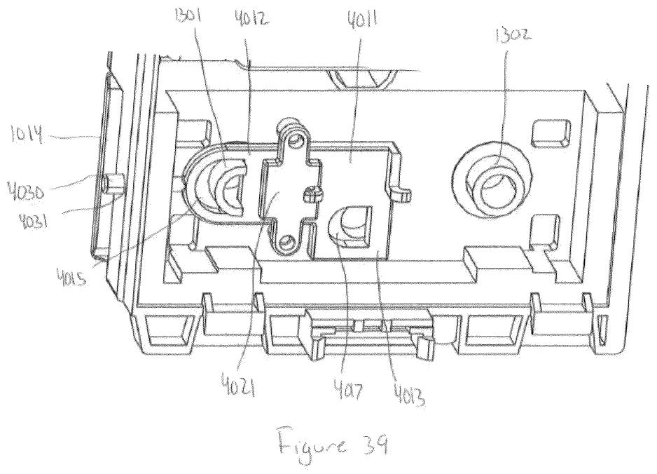

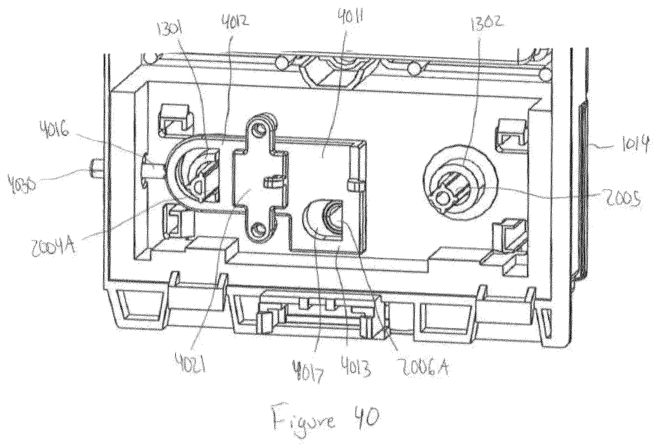

FIGS. 31-40 depict an embodiment of the control panel 1008, an embodiment of the opening assembly, and an embodiment of a lock assembly. In an aspect, the opening assembly is substantially similar to the embodiment of the opening assembly described above except that the opening rod 2006A is integrally connected on a lower portion of the backside of the release button 1014 and the first press rod 2004A is partially cross sectioned along an axis.

In an aspect, a first rod housing 1301, a second rod housing 1302, a first receiver 1303, and a second receiver 1304 extend from the internal wall of the control panel 1008 into the side chamber 1048. The first rod housing 1301 is the shape of a half cylinder and is hollow. The second rod housing 1302 is the shape of a cylinder and is hollow. The position of the first rod housing 1301 corresponds to the position of the first press rod 2004A such that it aligns with the edges of the press rod's 2004A entry point into the side chamber 1048 and allows the press rod 2004A to pass through. The position of the second rod housing 1302 corresponds to the position of the second press rod 2005 such that it aligns with the edges of the press rod's 2005 entry point into the side chamber 1048 and allows the press rod 2005 to pass through. The receivers 1303, 1304 are hollow cylinders. The receivers 1303, 1304 are positioned with one above the other and a space in between. The receivers 1303, 1304 are configured to secure a fastener such as a screw.

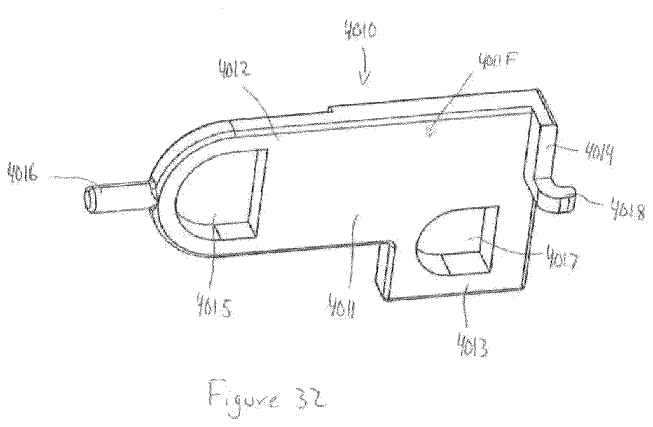

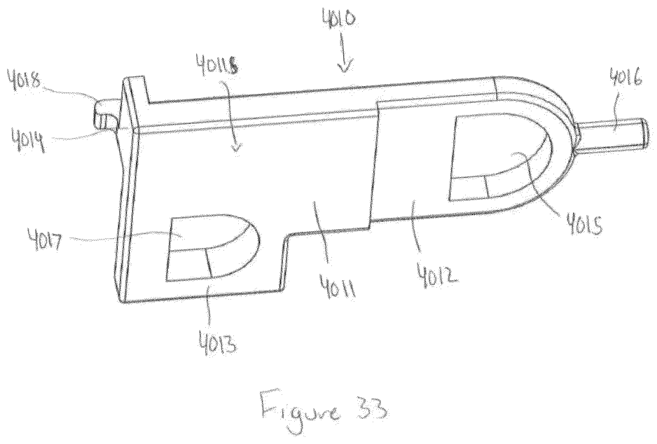

In an aspect, the lock assembly is in the side chamber 1048. The lock assembly includes a slide 4010, a plate 4020, and a button 4030. As depicted by FIGS. 32-33, the slide 4010 includes a main body 4011, a first branch 4012, a second branch 4013, and a tab 4014. The main body 4011 can be rectangular in shape. The main body has a first side 4011F and a second side 4011S. The height of the main body 4011 corresponds to the distance of the space between the receivers 1303, 1304, such that the slide 4010 can be positioned between the receivers 1303, 1304. The first branch 4012 extends from one edge of the main body 4011. The first branch 4012 includes a first aperture 4015 and a rod 4016 extends from the first branch 4012. The first aperture 4015 corresponds to the size of the first rod housing 1301 such that the first aperture 4015 can surround the first rod housing 1301. The second branch 4013 extends from an edge of the main body 4011 that is adjacent the edge of the main body 4011 that the first branch 4012 extends from. A second aperture 4017 is positioned on the main body 4011 and the second branch 4013. The second aperture 4017 corresponds to the diameter of the opening rod 2006A such that the opening rod 2006A can fit within the aperture 4017. The tab 4014 extends from the first side 4011F of the main body 4011 at the edge of the main body 4011 opposite the edge that the first branch 4012 extends from. A hook 4018 further extends from the tab 4014.

In an aspect, the plate 4020 includes a main body 4021, a first branch 4022, and a second branch 4023. The main body 4021 is rectangular. The main body 4021 includes a first side 4021F and a second side 4021S. The first branch 4022 and the second branch 4023 extend from opposite edges of the main body 4021. A first aperture 4024 is located at a terminal end of the first branch 4022 and a second aperture 4025 is located at a terminal end of the second branch 4023. The first aperture 4024 and the second aperture 4025 are configured to simultaneously align with the first receiver 1303 and second receiver 1304 respectively. In an aspect, fasteners can secure the plate 4020 to the receivers 1303, 1304 through the apertures 4024, 4025. A hook 4026 extends from the first side 4021F.

When the plate 4020 is secured to the receivers 1303, 1304 a gap is formed between the interior wall of the control panel 1008 and the second side 4021S of the plate 4020. The width of the slide 4010 corresponds to the width of the gap. In an aspect, the slide 4010 is positioned between the receivers 1303, 1304. The plate 4020 can then be secured to the receivers 1303, 1304 and the first side 4011F of the slide 4010 abuts the second side 4021S of the plate 4020 such that the slide 4020 is securely positioned in the gap while being able to slide along the second side 4021S of the plate 4020. The hook 4026 and the hook 4018 align such that a biasing member 4041, for example a spring, can be positioned between them.

In an aspect, the button 4030 is positioned in an aperture 4031 in the side of the housing of the control panel 1008. The button 4030 extends from the outside of the housing into the side chamber 1048. The button 4030 aligns with and contacts the rod 4016.

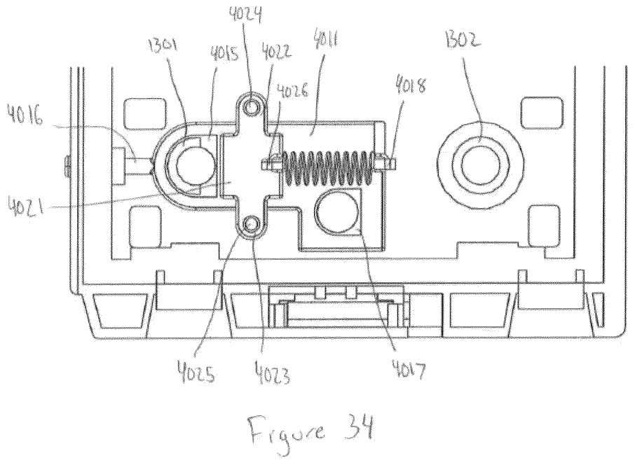

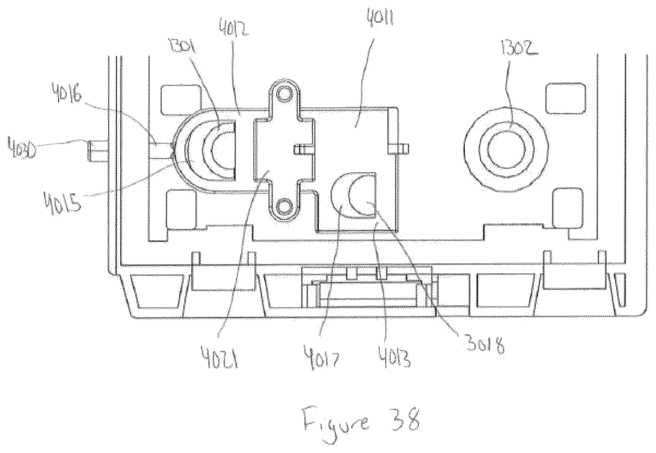

In an aspect, the lock assembly can be in a first position as depicted by FIGS. 38-40. In the first position, the first branch 4012 at least partially blocks the opening of the first rod housing 1301 and the second branch 4013 at least partially blocks the aperture 3018. In the first position, the rod 4016 extends into the aperture 4031 and causes the button 4030 to extend outward from the housing of the control panel 1008. The lock assembly can be in a second position as depicted by FIGS. 34-36. In the second position, the first aperture 4015 and the opening of the first rod housing 1301 align such that the opening of the first rod housing 1301 is not blocked. In the second position, the second aperture 4017 and the aperture 3018 align such that the aperture 3018 is not blocked. In the second position, the rod 4016 is housed entirely in the side chamber 1048 and the button 4030 extends into the side chamber 1048 to contact the rod.

When the lock assembly is in the first position, the opening assembly is prevented from moving from the first position to the second position, due to the slide 4010 blocking the apertures 1301, 3018. When the lock assembly is in the second position, the opening assembly can move from the first position to the second position when the release button 1014 is pushed. Therefor, the door 1004 can be opened when the lock assembly is in the second position, but not when the lock assembly is in the first position.

In an aspect, the biasing member 4041 biases the slide 4010 to the first position. For the lock assembly to move to the second position, a user must press the button 4030 thereby applying force to the rod 4016 and sliding the slide 4010. The user must provide sufficient force to overcome the force of the biasing member 4041. While the user holds the lock assembly in the second position through the button 4030, the user can press the release button 1014 thereby moving the opening assembly from the first position to the second position and causing the door 1004 to open. Once the user releases the release button 1014, the user can release the button 4030 and the lock assembly returns from the second position to the first position.

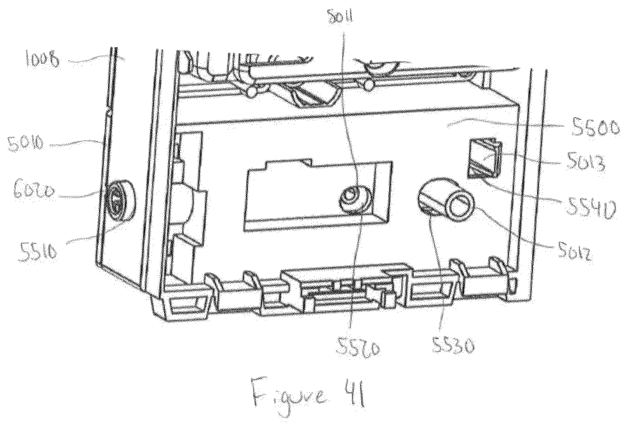

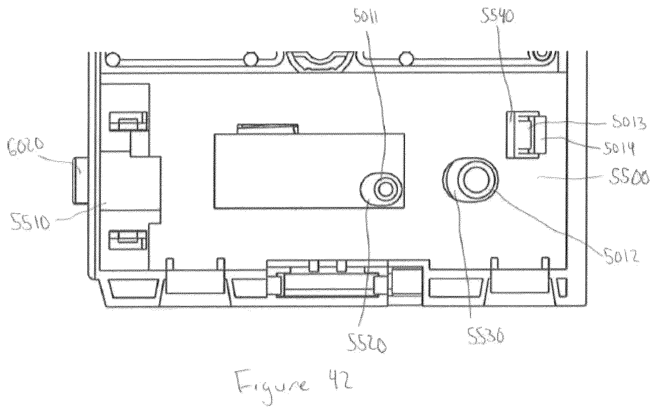

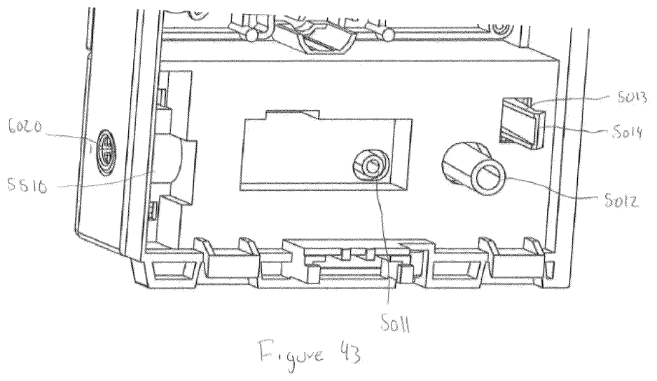

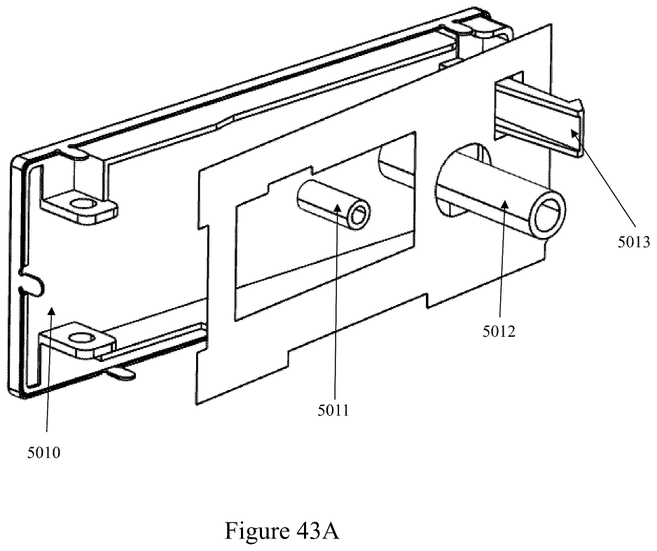

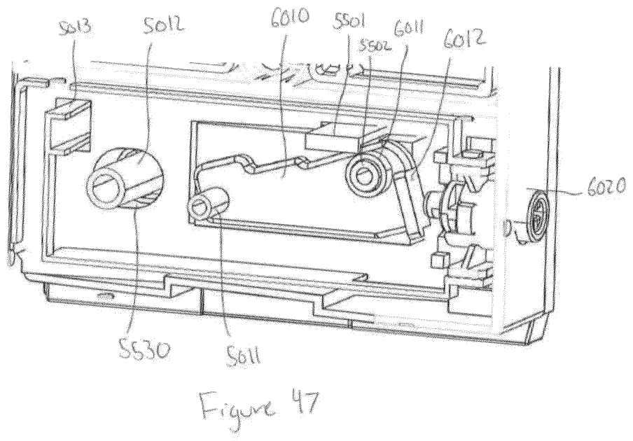

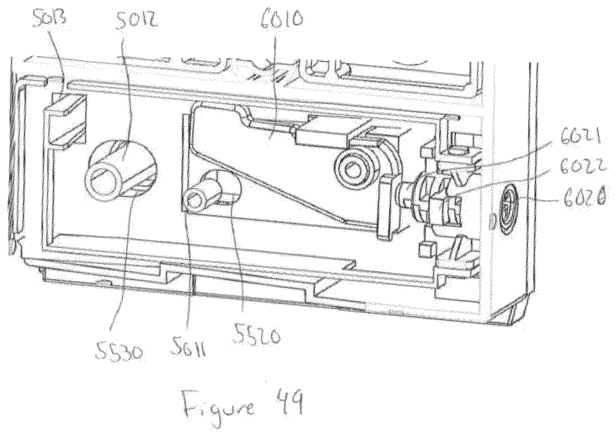

FIGS. 41-52 depict an embodiment of the control panel 1008, an opening assembly, and a lock assembly. The lock assembly is retained in a housing 5500, and the opening assembly is partially retained in the same housing 5500. The housing 5500 is located in the side chamber 1048 and is integrally connected to the internal side of the control panel 1008. The housing 5500 is rectangular in shape and includes a cylindrical outlet 5510, a first aperture 5520, a second aperture 5530, and a third aperture 5540. The outlet 5510 includes a first channel 5511 extending through the center of the outlet 5510, and a second channel 5512 extending from the first channel 5511 through one side of the outlet 5510. A button is housed within the outlet 5510 and extends through the housing 1002 and into the side chamber 1048. The first aperture 5520 is ovular-shaped, aligns with a first projection, and corresponds to the size of the first projection, but is slightly bigger such that the first projection can pass through the first aperture 5520. The second aperture 5530 is ovular-shaped, aligns with a second projection, and corresponds to the size of the second projection, but is slightly bigger such that the second projection can pass through the second aperture 5530. The third aperture 5540 is rectangular, aligns with a third projection, and corresponds to the size of the third projection such that the third projection can pass through the third aperture 5540. A first projection 5501 extends from the internal wall of the housing 5500 to the internal side of the control panel 1008 and is configured for a biasing member to attach to. A second projection 5502 extends from the internal wall of the housing 5500 to the internal side of the control panel 1008. The second projection 5502 is cylindrical and configured to hold an arm in a rotatable position.

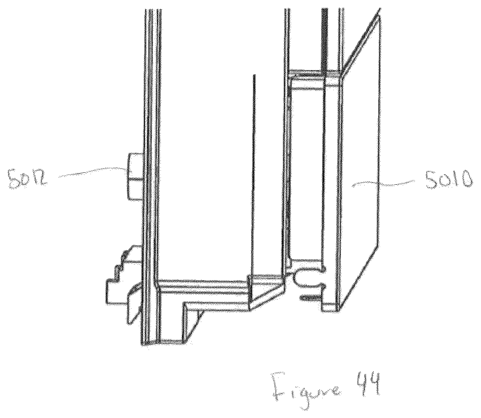

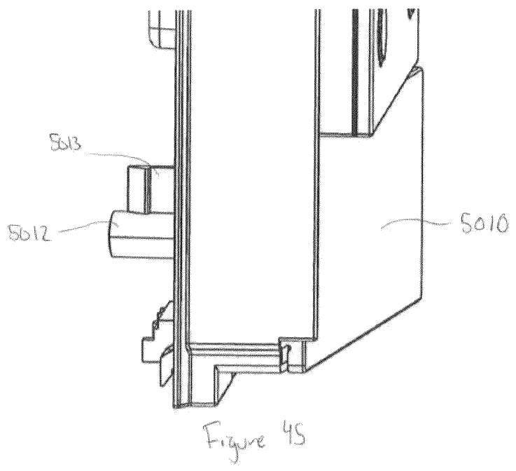

The opening assembly includes a release button 5010 rotatably connected at one end to the housing 1002 such that one end of the release button 5010 can be compressed as depicted in FIGS. 44-45. A first 5011, second 5012, and third 5013 projection extend from the back of the release button 5010 into the side chamber 1048. The third projection 5013 additionally extends through the third aperture 5540 of the housing 5500 and includes a tab 5014 that can abut an edge of the third aperture 5540, thereby retaining the third projection 5013 within the side chamber 1048. The opening assembly further includes a biasing member, such as a spring, positioned between the release button 5010 and the housing 5500. The biasing member biases the opening assembly to a first position (FIG. 44), such that the biasing member is decompressed and the release button is disengaged.

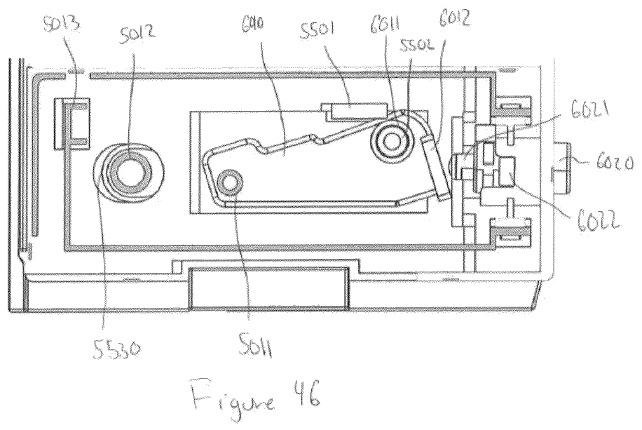

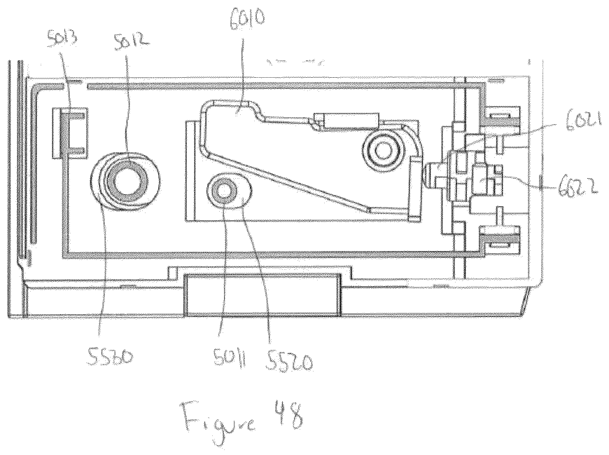

As depicted in FIG. 46, the locking assembly includes an arm 6010 and a button 6020. The arm is generally elongated and includes a first projection 6011 that is cylindrically-shaped and hollow, and a second projection 6012 adjacent the first projection configured to attach to a biasing member and engage with the button 6020. The first projection 6011 is mounted on the second projection 5502 in a rotatable configuration. A biasing member, such as a torsion spring, is attached between the second projection 6012 and the first housing projection 5501 and is configured to bias the arm to a first position (FIG. 46). In the first position the arm covers the housing aperture such that the first projection 5011 is prevented from entering the first aperture 5520. As depicted by FIG. 48, the arm 6010 can also be in a second position. In the second position the arm 6010 is positioned such that it does not block the first aperture 5520 and the first projection 5011 is able to enter the first aperture 5520. To move between the first and second positions the arm 6010 rotates about the second housing projection 5502.

As indicated above, the lock assembly includes a button 6020 that extends from outside of the housing 1002 and into the internal housing 5500 through the outlet 5510. The button 6020 is cylindrically-shaped and includes a first projection 6021 extending from its internal end to engage with the second projection 6012 of the arm, and a second projection 6022 extending from a side of the button 6020. The size and shape of the button 6020 corresponds to the size and shape of the first channel of the outlet 5510 such that the button 6020 fits within the first channel and the second projection 6022 corresponds to the size and shape of the second channel of the outlet 5510 such that it fits within the second channel.

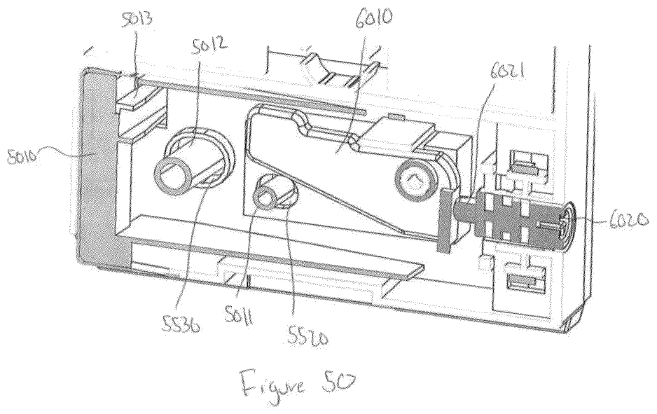

In an aspect, the biasing element biases the arm 6010 to the first position such that the aperture 5520 is blocked. The button 6020 can be pressed causing the button 6020 to slide through the first channel of the outlet 5510 such that the first projection 6021 engages with the second projection 6012 pushing the arm 6010 from the first position to the second position. As the button 6010 slides through the first channel the second projection 6022 slides through the second channel. As depicted by FIGS. 45 and 50, when the arm 6010 is in the second position the release button 5010 can be compressed causing the first projection 5011 to pass through the first aperture 5520 and the second projection 5012 to pass through the second aperture 5530. As the second projection 5012 passes through the second aperture 5530 it engages with the paddle 2010 causing the latch 1032 to release as described above, resulting in the door 1004 being opened. When the arm 6010 is in the first position, the release button 5010 is prevented from being compressed due to the arm 6010 blocking the aperture 5520, thereby preventing the second projection 5012 from passing through the second aperture 5530 and engaging with the paddle 2010, meaning that the door 1004 cannot be opened.

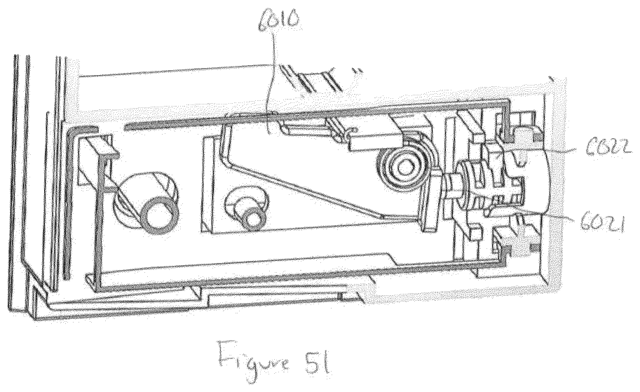

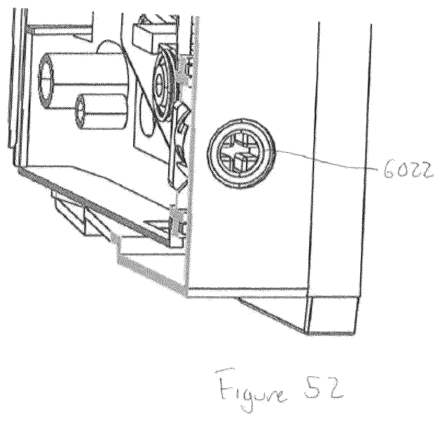

As depicted by FIGS. 51 and 52, in an aspect the button 6020 can be configured to rotate when in the compressed state. As the button 6020 rotates the second projection 6022 engages with the edge of the second channel of the outlet 5510 such that the button 6020 is locked in the compressed configuration. When the button 6020 is locked in the compressed configuration the first projection 6021 remains engaged with the second projection 6012 such that the arm 6010 is locked in the second position and the release button 5010 can be engaged to open the door 1004 without the user needing to press the button 6020.

Certain exemplary implementations will now be described to provide an overall understanding of the principles of the structure, function, manufacture, and use of the devices and methods disclosed herein. One or more examples of these implementations are illustrated in the accompanying drawings. Those skilled in the art will understand that the devices and methods specifically described herein and illustrated in the accompanying drawings are non-limiting exemplary implementations and that the scope of the present invention is defined solely by the claims. The features illustrated or described in connection with one exemplary implementation may be combined with the features of other implementations. Such modifications and variations are intended to be included within the scope of the present invention.

Further, in the present disclosure, like-named components of the implementations generally have similar features, and thus within a particular implementation each feature of each like-named component is not necessarily fully elaborated upon. Additionally, to the extent that linear or circular dimensions are used in the description of the disclosed systems, devices, and methods, such dimensions are not intended to limit the types of shapes that can be used in conjunction with such systems, devices, and methods. A person skilled in the art will recognize that an equivalent to such linear and circular dimensions can easily be determined for any geometric shape. Sizes and shapes of the systems and devices, and the components thereof, can depend at least on the anatomy of the subject in which the systems and devices will be used, the size and shape of components with which the systems and devices will be used, and the methods and procedures in which the systems and devices will be used. In addition, the terms “about” and “substantially” are defined as ranges based on manufacturing variations and variations over temperature and other parameters.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

One skilled in the art will appreciate further features and advantages of the invention based on the above-described implementations. Accordingly, the present application is not to be limited by what has been particularly shown and described, except as indicated by the appended claims. All publications and references cited herein are expressly incorporated by reference in their entirety.

What is claimed is:

1. A device, comprising:
a housing including a first aperture and a second aperture spaced from the first aperture;
a button positioned on the housing and configured to move relative to the housing from a first position to a second position;
a first rod extending from the button and configured to pass through the first aperture when the button is in the second position;
a second rod extending from the button and configured to pass through the second aperture when the button is in the second position; and
a blocking member positioned between the button and the housing, the blocking member including a surface configured to selectively cover the second aperture, thereby preventing the second rod from passing through the second aperture.

2. The device of claim 1, wherein the first rod is shorter than the second rod.

3. The device of claim 1, wherein the blocking member is selectively moved from a first position where the blocking member is misaligned with the first aperture to a second positioned where the blocking member is aligned with the first aperture.

4. The device of claim 3, wherein the blocking member is moved from the first position to the second position via an electric motor.

5. The device of claim 3, wherein the blocking member is moved from the first position to the second position via a button extending outward from the housing that abuts the blocking member.

6. The device of claim 3, wherein the blocking member moves from the first position to the second position along a linear path.

7. The device of claim 3, wherein the blocking member pivots about an axis from the first position to the second position.

8. A device, comprising:
a base plate including at least one sidewall extending upward from the base plate;
a corner portion formed from the sidewall and the base plate including a curved outer surface configured to prevent arc discharge on the sidewall or base plate; and
a plurality of oblong-shaped apertures positioned within the base plate, wherein the oblong apertures are configured to prevent arc discharge from occurring on the base plate.

9. The device of claim 8, wherein the device is configured to receive electromagnetic waves and prevent arc discharge from occurring on the device.

10. The device of claim 8, wherein the base plate includes a handle positioned on the base plate.

11. The device of claim 8, wherein the corner portion extends vertically upward from the sidewall.

12. The device of claim 11, wherein a non-conductive member is positioned on the curved outer surface of the corner portion.

13. A device, comprising:
a housing including an internal volume configured to receive a food product and an opening to allow fluid access to the internal volume;
an air movement device positioned above the internal volume and configured to generate an airflow;
a baffle having a first end and a second end extending partially along the opening and positioned inward from the opening towards the internal volume;
a channel extending outward from the opening;
a wall positioned within the channel to separate the channel into an inlet portion and an outlet portion, wherein the wall connects to the second end of the baffle;
wherein, a low pressure zone is formed at the first end of the baffle as the airflow is generated within the internal volume, drawing in external air from outside of the housing into the internal volume.

14. The device of claim 13, wherein the outlet portion of the channel is smaller than the inlet portion of the channel.

15. The device of claim 13, wherein air from within the internal volume is exhausted through the outlet portion of the channel when the airflow is generated.

16. The device of claim 13, wherein the baffle and wall create a venturi effect at the first end of the baffle.

17. The device of claim 13, wherein the first end of the baffle is open, and the second end of the baffle is closed, and mates with the wall within the channel to fluidly seal the inlet portion from the outlet portion along the channel.

18. A device, comprising:
a housing forming a cooking chamber therein, the cooking chamber comprising an inner wall having a rail thereon, wherein a first indent is positioned on the rail at a first position along an insertion axis, and a second indent is positioned on the rail at a second position along the insertion axis;
a microwave source positioned outside of the cooking chamber, and configured to emit microwaves;
an air movement configured to generate an airflow;
a heating element configured to heat the airflow to create a heated airflow within the cooking chamber; and
a container selectively removable from the cooking chamber along the insertion axis, the container comprising a top opening and a projection extending outward from the top opening, wherein a dedent is positioned on the projection,
wherein the first indent and the second indent correspond to the dedent such that the dedent is partially received by the first indent when the container is fully positioned within the cooking chamber, and the dedent is partially received by the second indent when the container is partially removed from the cooking chamber.

19. The device of claim 18, wherein a microswitch is positioned on the rail and configured to be engaged by the projection of the container when the container is fully inserted into the cooking chamber.

20. The device of claim 18, wherein the container is configured to be fully removable from the cooking chamber without the dedent being received by the second indent.
